(19) United States
(12) Patent Application Publication
(10) Pub. No.: US 2014/0152136 A1
(43) Pub. Date: Jun. 5, 2014

(54) DEVICES AND METHODS FOR MAGNETIC POLE RETENTION IN ELECTROMAGNETIC MACHINES

(71) Applicant: BOULDER WIND POWER, INC., Louisville, CO (US)

(72) Inventors: James David Duford, Polson, MT (US); Marc Eichinger, Louisville, CO (US); Stephane Eisen, Louisville, CO (US); Michael A. Kvam, Polson, MT (US); Derek Petch, Longmont, CO (US); David Samsel, Missoula, MT (US); James S. Smith, Lyons, CO (US); Brian J. Sullivan, Boulder, CO (US)

(73) Assignee: BOULDER WIND POWER, INC., Louisville, CO (US)

(21) Appl. No.: 13/692,083

(22) Filed: Dec. 3, 2012

(51) Int. Cl. H02K 1/27

(52) U.S. Cl. CPC H02K 1/27
USPC 310/156.08

(57) ABSTRACT

In some embodiments, an electromagnetic machine includes a rotor element configured for movement relative to a stator. The rotor element includes a magnetic support, a magnetic pole assembly, and a retainer. The magnetic support is formed, at least in part, from a ferromagnetic material and is configured to be coupled to the magnetic support. The retainer is coupled to both the magnetic support and the magnetic pole assembly. The retainer is further configured to be in a first state during a first time period and a second state during a second time period, after the first time period, such that during the second time period, the coupling of the magnetic pole assembly to the magnetic support is maintained.

### BACKGROUND

Some embodiments described herein relate to electromagnetic machines and more particularly to devices and methods for coupling a magnetic pole to a magnetic support of an element of the electromagnetic machine, such as a rotor element.

Permanent magnet electromagnetic machines (referred to as “permanent magnet machines” or “electromagnetic machines” herein) utilize magnetic flux from permanent magnets to convert mechanical energy to electrical energy or vice versa. Various types of permanent magnet machines are known, including axial flux machines, radial flux machines, and transverse flux machines, in which one component rotates about an axis or translates along an axis, either in a single direction or in two directions (e.g., reciprocating, with respect to another component). Such machines typically include windings to carry electric current through coils that interact with the flux from the magnets through relative movement between the magnets and the windings. In a common industrial application arrangement, the permanent magnets are mounted for movement (e.g., on a rotor or otherwise moving part) and the windings are mounted on a stationary part (e.g., on a stator or the like). Other configurations, typical for low power, inexpensive machines operated from a direct current source where the magnets are stationary and the machine's windings are part of the rotor (energized by a device known as a “commutator” with “brushes”) are clearly also available, but will not be discussed in detail in the following text in the interest of brevity.

In an electric motor, for example, current is applied to the windings in the stator, causing the magnets (and therefore the rotor) to move relative to the windings, thus converting electrical energy into mechanical energy. In a generator, application of an external force to the generator's rotor causes the magnets to move relative to the windings, and the resulting generated voltage causes current to flow through the windings-thus converting mechanical energy into electrical energy.

Surface mounted permanent magnet machines are a class of permanent magnet machines in which the magnetic poles are typically mounted on a ferromagnetic structure, or backing, commonly referred to as a magnetic support. In some such machines, multiple magnetic poles are permanently affixed or otherwise attached to the magnetic support in a manner that may not allow for easy and/or efficient removal of, for example, a single magnetic pole, if needed. For example, if a magnetic pole no longer functions at a sufficient level, it may be desirable to remove and replace that magnetic pole without having to remove a larger section of the machine.

Further, in some such machines, the handling of components that have significant attractive and/or repulsive forces to the magnet pole assembly and/or to the support structure (e.g., the magnetic support) can be challenging. Such magnetic forces can be difficult to control, as they typically increase exponentially as the components are brought closer together, and may cause deflection in unfavorable directions.

Thus, a need exists for improved apparatus and methods to couple a magnetic pole assembly to a magnetic support of an electromagnetic machine (e.g., a permanent magnet machine) to aid in the magnetization, handling and servicing of the electromagnetic machine.

### SUMMARY

Apparatus and methods for coupling a magnetic pole to a magnetic support of an element, such as a rotor element, included in an electromagnetic machine are described herein. In some embodiments, an electromagnetic machine includes a rotor element configured for movement relative to a stator. The rotor element includes a magnetic support, a magnetic pole assembly, and a retainer portion. The magnetic support is formed, at least in part, from a ferromagnetic material and is coupled to the magnetic pole assembly. The retainer is coupled to both the magnetic support and the magnetic pole assembly. The retainer portion is formed with a material configured to be in a first state when coupled to the magnetic pole assembly and the magnetic support, and can assume a second state different than the first state after a time period such that the magnetic pole assembly is maintained coupled to the magnetic support.

### BRIEF DESCRIPTION OF THE DRAWINGS

FIG. 1 is a schematic illustration of a rotor element, according to an embodiment.

FIG. 2 is a perspective view of a structure for an electromagnetic machine, according to an embodiment.

FIG. 3 is an exploded view of a portion of the structure for an electromagnetic machine of FIG. 2.

FIG. 4A is a tangential view of a portion of a rotor assembly, according to an embodiment; FIG. 4B is a cross-sectional perspective view of the portion of a rotor assembly of FIG. 4A taken along line 4B-4B in FIG. 4A; and FIG. 4C is a cross-sectional view taken along line 4C-4C in FIG. 4A.

FIG. 5 is a cross-sectional perspective view of a portion of a rotor assembly, according to different embodiments.

FIG. 6 is a radial view of a portion of a rotor element, according to an embodiment.

FIG. 7 is a radial view of a portion of a rotor element, according to an embodiment.

FIG. 8 is a cross-sectional view of a portion of the rotor element of FIG. 7, taken along the line 8-8 in FIG. 7.

FIG. 9 is a perspective view of a rotor element, according to an embodiment.

FIG. 10 is a cross-sectional view of a portion of the rotor element of FIG. 9, taken along the line 10-10 in FIG. 9.

FIG. 11 is a radial view of a portion of a rotor element, according to an embodiment.

FIG. 12 is a radial view of a portion of a rotor element, according to an embodiment.

FIG. 13 is a cross-sectional view of a portion of the rotor element of FIG. 12, taken along the line 13-13 in FIG. 12.

FIG. 14 is a cross-sectional view of a portion of the rotor element of FIG. 12, taken along the line 14-14 in FIG. 13.

FIG. 15 is a cross-sectional radial view of a portion of a rotor element, according to an embodiment.

FIG. 16 is a cross-sectional axial view of a portion of the rotor element of FIG. 15, taken along the line 16-16 in FIG. 15.

FIG. 17 is an axial view of a retainer member of the rotor element of FIG. 15.

FIG. 18 is a perspective view of a coupler of the rotor element of FIG. 15.

FIG. 19 is a cross-sectional radial view of a portion of a rotor element, according to an embodiment.

FIG. 20 is a perspective view of a coupler of the rotor element of FIG. 19.

FIG. 21 is a cross-sectional view of a portion of a rotor element, according to another embodiment.

FIG. 22 is a top view of a portion of a rotor element, according to another embodiment, and FIG. 23 is a cross-sectional view of the portion of the rotor element taken along line 23-23 in FIG. 22.

FIG. 24 is a top view of a portion of a rotor element, according to another embodiment, and FIG. 25 is a cross-sectional view of the portion of the rotor element taken along line 25-25 in FIG. 24.

FIG. 26 is a top view of a portion of a rotor element, according to another embodiment, and FIG. 27 is a cross-sectional view of the portion of the rotor element taken along line 27-27 in FIG. 26.

### DETAILED DESCRIPTION

Apparatus and methods for coupling a magnetic pole to a magnetic support of a rotor element included in an electromagnetic machine are described herein. In some embodiments, the magnetic support can be a support member of the rotor element. The coupling methods described herein can be used to couple one or more magnetic pole assemblies to the support member. A rotor element can be, for example, a portion or segment of a rotor assembly that can be coupled to other portions or segments to form the rotor assembly. In some embodiments, the magnetic support is a discrete component to which one or more magnetic pole assemblies can be coupled to form a magnet assembly. In such embodiments, one or more of the magnet assemblies can be coupled to a support member of a rotor element of a rotor assembly.

In some embodiments, an electromagnetic machine includes a rotor element configured for movement relative to a stator. The rotor element includes a magnetic support, a magnetic pole assembly, and a retainer portion. The magnetic support is formed, at least in part, from a ferromagnetic material and is coupled to the magnetic pole assembly. The retainer portion is coupled to both the magnetic support and the magnetic pole assembly. The retainer portion is formed with a material configured to be in a first state when coupled to the magnetic pole assembly and the magnetic support, and can assume a second state different than the first state after a time period such that the magnetic pole assembly is maintained coupled to the magnetic support.

In some embodiments, an electromagnetic machine includes a rotor element configured for movement relative to a stator. The rotor element includes a magnetic support, a magnetic pole assembly, a retainer member, and a coupler. The magnetic support is formed, at least in part, from a ferromagnetic material and is coupled to the magnetic pole assembly. The retainer member is coupled to both the magnetic support and the magnetic pole assembly with the coupler. The retainer member is deformable by the coupler such that the magnetic pole assembly is maintained coupled to the magnetic support.

In some embodiments, an electromagnetic machine includes a rotor element configured for movement relative to a stator. The rotor element includes a magnetic support, a magnetic pole assembly, and a retainer member. The magnetic support is formed, at least in part, from a ferromagnetic material. The retainer member is slidably coupled to the magnetic support and configured to couple the magnetic pole assembly to the magnetic support.

In some embodiments, an electromagnetic machine includes a rotor element configured for movement relative to a stator. The rotor element includes a magnetic support, a first magnetic pole assembly, a second magnetic pole assembly, a retainer member, and a coupler. The magnetic support is formed, at least in part, from a ferromagnetic material and is coupled to both the first magnetic pole assembly and the second magnetic pole assembly. The retainer member includes a first coupling portion and a second coupling portion. The first coupling portion of the retainer member is matingly coupled to a coupling portion of the first magnetic pole assembly and to a coupling portion of the second magnetic pole assembly. The second coupling portion of the retainer member is coupled to the magnetic support. The coupler can maintain the retainer member coupled to the first magnetic pole assembly, the second magnetic pole assembly, and the magnetic support.

Electromagnetic machines as described herein can be various types of permanent magnet machines, including axial flux machines, radial flux machines, and transverse flux machines, in which one component rotates about an axis or translates along an axis, either in a single direction or in two directions (e.g., reciprocating, with respect to another component). Such machines typically include windings to carry electric current through coils that interact with the flux from the magnets through relative movement between the magnets and the windings. In a common industrial application arrangement (including the embodiments described herein), the permanent magnets are mounted for movement (e.g., on a rotor or otherwise moving part) and the windings are mounted on a stationary part (e.g., on a stator or the like).

Some embodiments described herein address axial field, air core, surface mounted permanent magnet generator rotor/stator configurations; but it should be understood that the features, functions and methods described herein can be implemented in radial field, transverse field and embedded magnet configurations that also employ an air core stator configuration. Embodiments described herein can also be applied to electrically excited rotors commonly found in industrial and utility applications, such as wound field synchronous and devices common in the wind energy conversion industry known as “doubly fed induction generators.” Embodiments described herein can be used in relatively large electromagnetic machines and/or components such as those found in wind power generators. Embodiments described herein can also be implemented in other types of electromagnetic machines and mechanisms. For example, embodiments described herein can be implemented in other types of generators and/or motors, such as, for example, iron core electromagnetic machines.

As used herein, the term “radial direction” can refer to, for example, a direction radially inward toward an axis of rotation of an electromagnetic machine or radially outward from the axis of rotation. In this manner, the term “radial view” can refer to a view of a plane that is perpendicular to the radial direction.

As used herein, the term “axial direction” can refer to, for example, a direction parallel to an axis of rotation of an electromagnetic machine. For example, in an electromagnetic machine having a rotor rotatably movable relative to a stator, an axial direction can be a direction parallel to the axis of rotation of the rotor.

As used herein, the term “tangential direction” can refer to, for example, a direction that is tangent to the direction of rotation of an electromagnetic machine. For example, in an electromagnetic machine having a rotor rotatably movable relative to a stator, a tangential direction can be a direction parallel to the direction of rotation of the rotor.

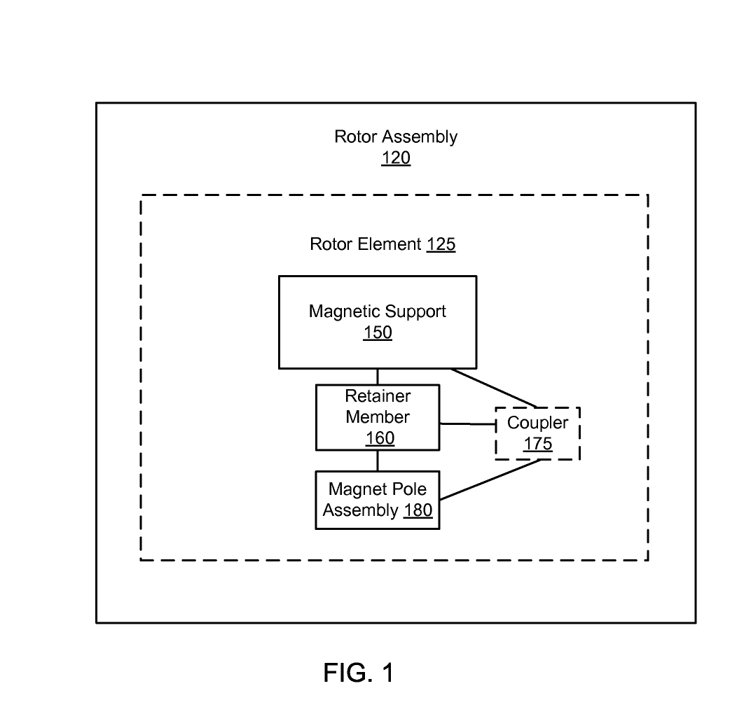

FIG. 1 is a schematic illustration of a rotor assembly that can be included in a structure for an electromagnetic machine. A rotor assembly 120 can include one or more rotor elements 125 (only one rotor element 125 is shown in FIG. 1) that can be coupled together to form at least a portion of the rotor assembly 120. The rotor assembly 120 can be disposed in an electromagnetic machine, such as, for example, an axial flux, radial flux, transverse flux machine, or translational linear electromagnetic machines. In some embodiments, the rotor assembly 120 can be, for example, included in a structure implemented in a generator or a motor (not shown in FIG. 1) and be configured to move relative to a stator assembly (not shown in FIG. 1). For example, in some embodiments, the rotor assembly 120 can rotate relative to the stator assembly (e.g., rotates with the direction of flux from rotor to stator generally in the axial or radial direction) or can move linearly relative to the stator assembly.

The rotor element 125 can include one or more magnetic supports 150, one or more retainer members or portions 160, and one or more magnetic pole assemblies 180. The magnetic pole assemblies 180 (also referred to herein as “magnetic pole”) can be any suitable configuration. For example, in some embodiments, the magnetic poles 180 can include an array of magnets such as permanent magnets, electromagnets or a combination thereof. For example, in an induction machine or wound field synchronous machine, the magnets are electromagnets. In some embodiments, the magnetic poles 180 can be configured as a flux focusing magnetic pole assembly substantially similar in form and/or function to those described in U.S. patent application Ser. Nos. 13/437,639 and 13/438,062, each filed Apr. 2, 2012, the disclosures of which are incorporated herein by reference in their entirety (referred to henceforth as the “'639 and '062 applications”).

The magnetic support 150 can receive and/or be coupled to any suitable number of magnetic poles 180. For example, in some embodiments, multiple magnetic poles 180 can be coupled to the magnetic support 150. In other embodiments, a single magnetic pole 180 is coupled to the magnetic support 150. As described above, the retainer member 160 can couple one or more magnetic pole assemblies 180 to the magnetic support 150. For example, the retainer member 160 can be placed in contact with at least a portion of a magnetic pole 180 and at least a portion of the magnetic support 150 to couple the magnetic pole 180 to the magnetic support 150. In some embodiments, the rotor element 120 can include more than one retainer member 160.

The magnetic support 150 can be any suitable shape, size, or configuration. For example, in some embodiments, the magnetic support 150 can be a backing member as described in detail in U.S. patent application Ser. No. 13/568,791, filed, Aug. 7, 2012, the disclosure of which is incorporated herein by reference in its entirety (referred to henceforth as the '791 application). In such an embodiment, one or more magnetic poles 180 can be coupled to the backing member with one or more retainer members 160 (collectively referred to as a magnetic assembly) and can collectively be coupled to a support member (not shown in FIG. 1) of the rotor element 125. Such a support member is described in more detail below. In some such embodiments, the magnetic support 150 can be formed at least in part from a ferromagnetic material. In some embodiments, when the magnetic support 150 is magnetically permeable (e.g., formed with a ferromagnetic material) with suitable magnetic hysteresis properties, the magnetic support 150 can additionally be permanently magnetized. For example, magnetization of a magnetic pole 180 coupled to the magnetic support 150 can result in the magnetization of the magnetic support 150. In some embodiments, the magnetic support (e.g., a backing member as described above) 150 can be magnetized individually (e.g., prior to coupling a magnetic pole 180 thereto). With such magnetization, improvements to magnetic performance can be achieved, such as, for example, providing an additional source of magnetic field, and improving the permeability of the magnetic support (e.g., backing member) 150.

The support member (referred to above) of the rotor element 125 can be any suitable structure. In some embodiments, the support member can be, for example, the same as or similar to the support members described in the '791 application and/or in U.S. patent application Ser. No. 13/152,164, filed Jun. 2, 2011, the disclosure of which is incorporated herein by reference in its entirety (referred to henceforth as the “'164 application). In some embodiments, the support member can be formed from a ferromagnetic material. In other embodiments, the support member need not be formed from a ferromagnetic material. For example, if the magnetic poles 180 are coupled to a backing member that is formed with ferromagnetic material (as described above), the support member may not be formed with a ferromagnetic material. In addition, one or more support members can be coupled to a hub via radial supports (not shown in FIG. 1). In this manner, any suitable number of support members can be coupled together to form a portion of the rotor assembly 120.

In alternative embodiments, the magnetic support 150 is a support member (not shown in FIG. 1) of the rotor element 120 such as support member described above and as described in the '164 application incorporated by reference above. For example, in such an embodiment, a separate or discrete backing member(s) is not included, but rather, the magnetic poles 180 are coupled directly to the support member with one or more retainer members 160. In such an embodiment, the support member can be formed with a ferromagnetic material.

As described above, the magnetic poles 180 can be coupled to the magnetic support 150 (e.g., to a backing member or support member of the rotor assembly 120) with a retainer member(s) 160. The retainer member 160 can be any suitable shape, size, or configuration. For example, in some embodiments, the retainer member 160 can be formed with a material, such as, for example, a flowable material that is initially soft (e.g., a liquid or substantially liquid) and that can subsequently harden. For example, the retainer member 160 can be formed with a material, such as, for example, a plastic, a fiber reinforced material, or a metal, such as, for example, aluminum. In such embodiments, the material of the retainer member 160 can be a disposed within a channel defined between two adjacent pole assemblies 180, and the material can also flow into a channel defined by the magnetic support 150. More specifically, the retainer member 160 can be formed with a material that can be disposed on a portion of the magnetic pole 180 and a portion of the magnetic support 150 while in a first state and, after a given period of time, can assume a second state (e.g., set or harden) to retain the magnetic poles 180 coupled to the magnetic support 150. In some embodiments, the retainer member 160 can be applied to two adjacent magnetic poles 180 such that the material surrounds or encases at least a portion of the magnetic poles 180 and also flows into the channel defined by the magnetic poles 180 and the channel defined by the magnetic support 150 as described above.

In some embodiments, the rotor element 120 can include one or more couplers 175 that can be used with the retainer member 160 such that the retainer member 160 and the coupler 175 collectively retain the magnetic pole 180 coupled to the magnetic support 150. For example, in some embodiments, the retainer member 160 can include a portion that engages the magnetic pole assembly 180 and a portion that engages the magnetic support 150. In such embodiments, a coupler 175 can extend through an opening defined by the retainer member 160 and an opening defined by the magnetic support 150, and a nut (not shown in FIG. 1) can be used to threadably secure the coupler 175 to the retainer member 160 and the magnetic support 150. In other embodiments, the retainer member 160 can engage a first magnetic pole 180 and a second magnetic pole 180 and extend through an opening defined by the magnetic support 150, and a nut can be used to threadably secure the coupler 175 to the retainer member 160 and the magnetic support 150 in a similar manner. In some embodiments, the coupler 175 can be a cleat. In such cases, the retainer member 160, the coupler 175, and the nut (if used) can exert a compression force on a portion of the magnetic pole assembly 180 and the magnetic support 150 such that the magnetic pole assembly (or assemblies) 180 and the magnetic support 150 are coupled together.

In some embodiments, the magnetic support 150 can define an opening (or openings) that can receive a wedge portion (or portions) of the retainer member 160 and that includes an angled surface portion that can slidably engage a ramped portion of the magnetic support 150. In such embodiments, a coupler 175 can be disposed within a threaded opening of the magnetic support 150 such that a portion of the coupler 175 engages a surface of the retainer member 160, for example, in a similar manner as a set screw. In this manner, the coupler 175 can be advanced relative to the magnetic support 150 to thereby couple the retainer member 160 and the magnetic poles 180 to the magnetic support 150.

In other embodiments, the coupler 175 can be or include a wedge that defines an opening (e.g., a slot or a keyway) configured to slidably receive an end portion of the retainer member 160. In such embodiments, the coupler 175 can be moved such that the coupler 175 engages a surface of the retainer member 160 and a surface of the magnetic support 150. For example, in an axial flux type machine, the coupler 175 can be moved in a radial direction, and in a radial flux type machine, the coupler 175 can be moved in an axial direction. In this manner, the coupler 175 can move the retainer member 160 in, for example, an axial direction relative to the magnetic support 150, thereby moving or drawing the retainer member 160 against a portion of the magnetic poles 180 and provide, for example, a preload compression force to the magnetic poles 180 and the magnetic support 150. In still other embodiments, the retainer member 160 can define an opening or cutout configured to slidably receive a portion of the coupler 175. For example, the coupler 175 can be wedge that can be slidably received within the cutout of the retainer member 160 and within a notch of the magnetic support 150 to secure the retainer member 160 and thus, to couple the magnetic poles 180 to the magnetic support 150.

In some embodiments, the retainer member 160 can be configured to deform (e.g., elastically or plastically) in response to the coupler 175 being disposed within an opening defined by the retainer member 160. For example, in some such embodiments, the retainer member 160 can be disposed between and engage a portion of two adjacent magnetic poles 180 and a coupler 175 can extend through an opening defined by the retainer member 160 and an opening defined by the magnetic support 150. In this manner, the retainer member 160 can have a first configuration prior to the coupler 175 being coupled thereto, and be moved to a second, expanded configuration when the coupler 175 engages the retainer member 160. When the retainer member 160 is engaged by the coupler 175, the retainer member 160 can elastically deform to couple the magnetic pole 180 to the magnetic support 150. In some embodiments, the retainer member 160 can plastically deform when engaged by the coupler 175.

In still other embodiments, the magnetic support 150 can include a bracket or coupling portion (not shown in FIG. 1) that can slidably received a portion of the retainer member 160. In some such embodiments, the bracket can be formed integrally or monolithically with the magnetic support 150. In some such embodiments, the coupler 175 can be used to couple the bracket to the magnetic support 150. In such embodiments, a first end portion of the retainer member 160 can engage two adjacent magnetic poles 180 and a second end portion of the retainer member 160 can be slidably received with a slot or channel defined by the bracket of the magnetic support 150. For example, in some embodiments, the second end portion of the retainer member 160 can include a T-shaped portion that can be received within a mating slot or channel defined by the bracket of the magnetic support 150.

Expanding further, in some such embodiments, the retainer member 160 can engage one or more magnetic poles 180 and the magnetic support 150 while in a first state and can assume a second state such that the retainer member 160 exerts a compression force on a portion of the magnetic pole 180 and a portion of the magnetic support 150. For example, in some embodiments, the retainer member 160 can be heated such that the retainer member 160 thermally expands (e.g., the first state). The retainer member 160 can then be coupled to the magnetic pole 180 (or multiple magnetic poles 180) and the magnetic support 150 and allowed to cool such that the retainer member 160 contracts. Thus, as the retainer member 160 contacts, the retainer member 160 can exert a compression force on a portion of the magnetic pole assembly(ies) 180 and a portion of the magnetic support 150

While not shown in FIG. 1, in some embodiments, at least a portion of the magnetic support 150, the magnetic pole(s) 180, the retainer member(s) 160, and/or the coupler 175 can be sealed in a corrosion resistant coating after being coupled (e.g., via any of the methods described above). In some embodiments, the corrosion resistant coating can include plating, painting, chemical conversion, or the like. In some embodiments, the magnetic pole 180 can be covered in a polymer such as epoxy, to form a relatively thick and dimensionally consistent package. For example, the coating of a magnetic pole assembly 180 can be sufficiently precise such that a first magnetic pole assembly 180 coupled to a first magnetic support 150 is substantially similar in size (e.g., thickness, width and/or length) to a second magnetic pole assembly 180 coupled to a second magnetic support 150).

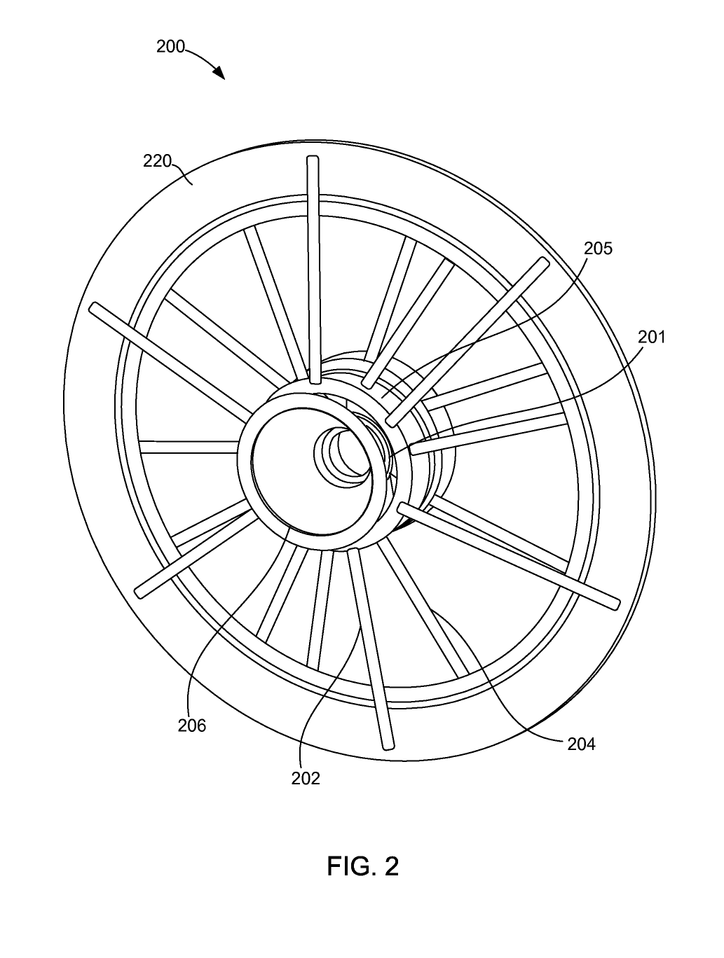

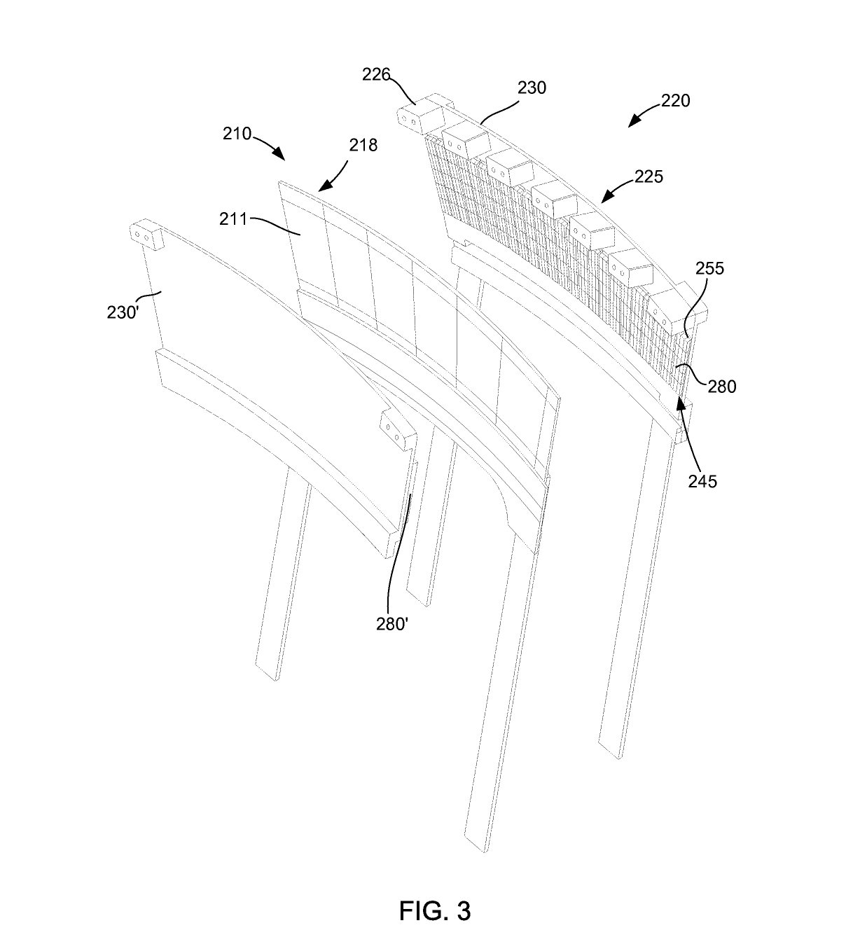

FIGS. 2 and 3 illustrate a portion of a structure for an electromagnetic machine 200 (also referred to herein as “machine structure”), according to an embodiment. The machine structure 200 includes a segmented annular rotor assembly 220 (also referred to as “rotor assembly”) and a segmented annular stator assembly 210 (also referred to as “stator assembly” (see, e.g. FIG. 3)). The rotor assembly 220 can include multiple rotor elements or portions 225 and the stator assembly 210 can include multiple stator segments or portions 218 that can be coupled together to form the machine structure 200.

The stator assembly 210 can include or support, for example, an air core type stator to support a set of conductive windings. For example, the stator segment 218 can include stator portions 211 (FIG. 3) that can be substantially similar to stator portions described in U.S. Patent Application Publication No. 2011/0273048, the disclosure of which is incorporated herein by reference in its entirety. Each stator portion 211 can include a printed circuit board sub-assembly (not shown in FIGS. 2 and 3), or other means known of defining and/or structurally supporting the windings with non-ferromagnetic materials. In some embodiments, the printed circuit board sub-assemblies can be similar to those described in U.S. Pat. No. 7,109,625, the disclosure of which is incorporated herein by reference in its entirety. In some embodiments, a stator assembly 210 can include or support a conventional iron-core construction arranged similarly to the air core concept described above.

The machine structure 200 can also include multiple stator supports 204 configured to couple the stator assembly 210 to a stator hub 206 (see, e.g. FIG. 2). Similarly, the machine structure 200 can include multiple rotor supports 202 configured to couple the rotor assembly 220 to a bearing 201 (see, e.g. FIG. 2). The bearing 201 can be attached to a rotor hub 205 that extends through a central opening of the stator hub 206 and can function similar to an axle to provide for rotational movement of the rotor assembly 220 relative to the stator assembly 210.

As shown in FIG. 3, a rotor segment or element 225 includes support members 230 and 230′ that are disposed on opposite sides of a stator segment 218. The support members 230 and 230′ can be any suitable shape, size, or configuration and can be formed from any suitable material. For example, in some embodiments, the support members 230 and 230′ are formed from a ferromagnetic material. In other embodiments, the support members 230 and 230′ need not be formed from a ferromagnetic material. The support member 230′ can be substantially similar in form and function as the support member 230. Therefore, the support member 230′ is not described in detail and it should be understood that a discussion of the support member 230 applies to the support member 230′ unless explicitly described otherwise. In alternative embodiments, a rotor segment 225 may only include a single support member 230, for example, in a single sided rotor assembly.

As shown in FIG. 3, the support member 230 can be coupled to the support member 230′ with spacer blocks 226 at a radially outer portion of support members 230 and 230′, such that the support members 230 and 230′ can rotate together as a single, structurally rigid subassembly. For example, in some embodiments, the spacer blocks 226 can be coupled to the support members 230 and 230′ with a bolt, screw or other coupling mechanism through openings (not shown) defined in the support member 230. In some embodiments, the support members 230 and 230′ can be integrally or monolithically formed with the spacer blocks 226 (in other words, the spacer blocks 226 and the support member 230 are a single component).

As described in the '791 application incorporated by reference above, the support member 230 can include any number of coupling portions (not shown in FIGS. 2 and 3) to which multiple magnetic assemblies 245 can be coupled thereto. For example, as shown in FIG. 3, the magnetic assemblies 245 can each include a backing member 255 and one or more magnetic pole assemblies 280 coupled thereto. The magnetic pole assemblies 280 (also referred to herein as “magnetic poles”) can each be coupled to the backing members 255 via one or more of the coupling methods described herein. For example, one or more magnetic pole assemblies 280 can be coupled to a backing member 255 with one or more retainers (not shown in FIGS. 2 and 3) as described above. In this manner, any suitable number of magnetic assemblies 245 can be coupled to the support member 230 to form the rotor segment 220 (as described in detail in the '791 application).

As described above, in an alternate embodiment, a rotor segment or element 220 need not include a discrete backing member (e.g., backing members 255) (e.g., as shown in FIG. 3). In such embodiments, one or more magnetic poles can be coupled directly to the support member (e.g., support members 230 and 230′) of the rotor element. In this manner, the support member is the magnetic support to which the magnetic pole assemblies are coupled as described above with reference to FIG. 1.

Having described above some general principles regarding a rotor element of a rotor assembly, various specific embodiments of a rotor element are described in detail below. The various embodiments described below can each be included within a rotor assembly (e.g., rotor assembly 120, 220 described above) of an electromagnetic machine. Each rotor element described below can include one or more magnetic supports to which one or more magnetic pole assemblies can be coupled. It should be understood that in each embodiment of a rotor element described below, the magnetic support can be a backing member (e.g., backing member 255 described above) that can be coupled to a support member (e.g., support member 230 described above) of the rotor element, or the magnetic support can be a support member (e.g., support member 230 described above) of the rotor element.

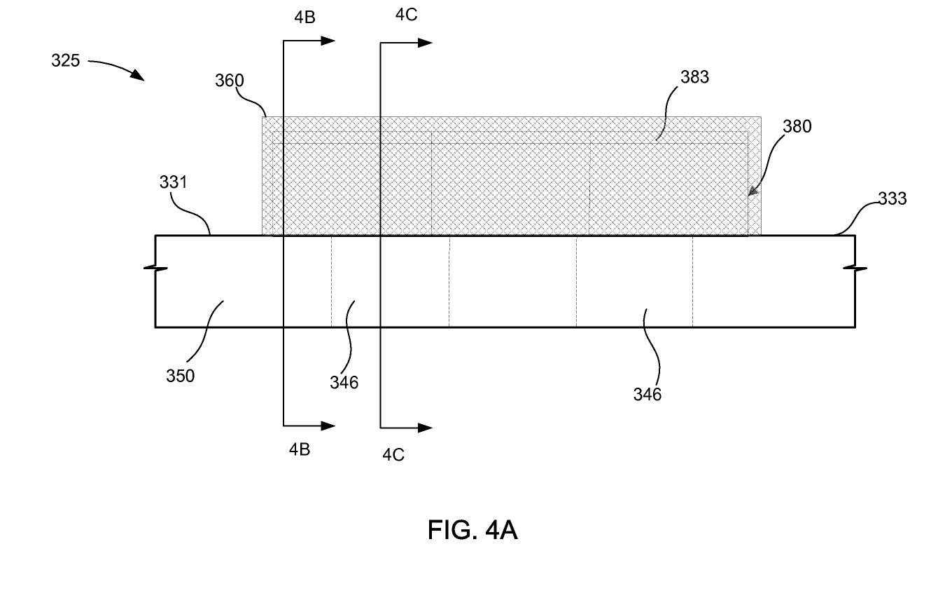

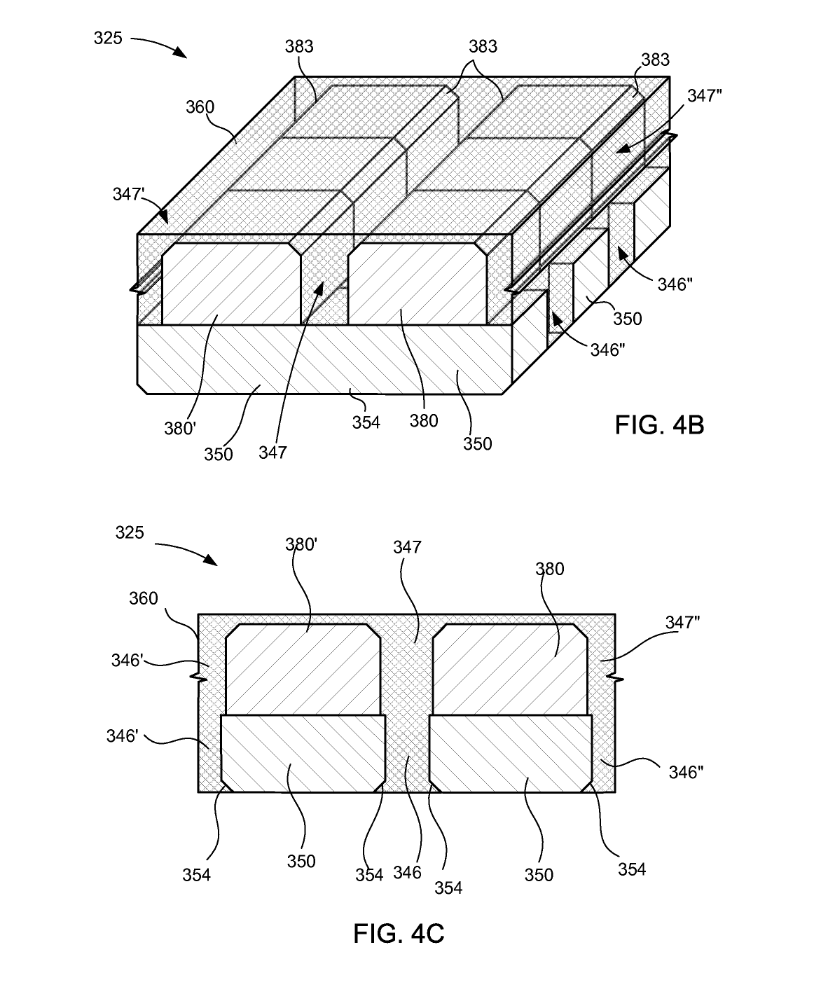

FIGS. 4A-4C illustrate a portion of a rotor element 325, according to an embodiment. The rotor element 225 can be included in a rotor assembly of an electromagnetic machine as described above. The rotor element 325 includes a first magnetic pole assembly 380 (also referred to herein as “magnetic pole”) and a second magnetic pole assembly 380′ (also referred to herein as “magnetic pole”) each coupled to a magnetic support 350.

The magnetic poles 380, 380′ can each be any suitable magnetic assembly or array (e.g., can include any suitable number of individual magnets in any suitable arrangement). For example, in this embodiment, the magnetic poles 380, 380′ each include three magnets. In alternative embodiments, the magnetic poles 380, 380′ can include more or less magnets. In some embodiments, the magnetic poles 380, 380′ can be configured to, for example, focus the flow of magnetic flux to increase the flux density of the magnetic poles 380, 380′ as described in detail in the '639 and '062 applications incorporated by reference above. In some embodiments, a magnetic pole includes a single magnet.

As shown in FIGS. 4A-4C, the magnetic poles 380, 380′ are each disposed on the magnetic support 350. The magnetic support 350 can be any suitable shape, size, or configuration. The magnetic support 350 can be formed from a ferromagnetic material such as, for example, steel. In this manner, the magnetic support 350 can be configured to direct a portion of a magnetic flux. In this embodiment, the magnetic support 350 defines multiple channels 346 (see, e.g., FIG. 4A) that include a tapered or flared portion defined by angled surfaces 354 of the magnetic support 350, as shown in FIG. 4C. Additional channels 346′ and 346″ (only a portion of which are shown in FIGS. 4B and 4C) can also be defined by the magnetic support 350.

As shown in FIG. 4B, the magnetic poles 380, 380′ collectively define a channel 347 between the magnetic poles 380, 380′ that can be in fluid communication with the channels 346 of the magnetic support 350. Each magnetic pole 380, 380′ also includes tapered or chamfered portions 383. In alternative embodiments, the magnetic poles 380, 380′ can include stepped or rabbeted portions or edges rather than tapered or chamfered portions 383. In some embodiments, the radial ends of the magnetic poles 380, 380′ can also include tapered or rabbeted portions. Although only two magnetic poles 380, 380′ are illustrated in FIG. 4, it should be understood that more magnetic poles 380 can be disposed adjacent the magnetic poles 380, 380′ and define additional channels 347′, 347″ (only a portion of which are illustrated in FIGS. 4B and 4C). For example, more magnetic poles 380, 380′ can be coupled to the magnetic support 350 or to an adjacent magnetic support (not shown) of the rotor element 325.

In alternative embodiments, the magnetic support 350 can include one or more elongate channels 346 that extend substantially along an axial length of the magnetic poles 380, 380′. In such an embodiment, a radial outward portion 333 and a radial inward portion 331 (shown in FIG. 4A) of the magnetic support 350 can provide rigidity to the magnetic support 350. In other alternative embodiments, the magnetic support 350 may not include channels 346. In such an embodiment, the magnetic poles 380, 380′ can be surface bonded to the magnetic support 350.

In this embodiment, the retainer member 360 (also referred to herein as “retainer portion”) is in the form of a material that can be initially applied to the magnetic poles 380 and 380′ as a soft or substantially soft material and that can subsequently harden as described above with reference to FIG. 1. For example, the material of the retainer member 360 can be a plastic, a fiber reinforced material, or a metal, such as, for example, aluminum. In this embodiment, the material of the retainer member 360 can be disposed on a top portion of the magnetic poles 380, 380′ such that the material surrounds or encases at least a portion of the magnetic poles 380, 380′ and flows within the channels 347 between the magnetic poles 380, 380′ (and between adjacent magnetic poles). The material can also flow within the channels 346 of the magnetic support 350, such that a portion of the material is disposed within the flared portion of the channels 346 of the magnetic support 350. Thus, as the material hardens, the retainer member 360 can maintain the magnetic poles 380, 380′ coupled to the magnetic support 350. More specifically, the material of the retainer member 360 can be applied to the magnetic poles 380, 380′ at a first time period while in a first state (e.g., a liquid or substantially liquid state) and can assume a second state (e.g. a solid or substantially solid) at a second time period. In other words, after a given time period, the material of the retainer member 360 can cure or set.

While in the second state, the retainer portion 360 surrounds or encases both a portion of the first magnetic pole 380 and a portion of the second magnetic pole 380′ and also engages the angled surfaces 354 of the magnetic support 350 such that the retainer portion 360 maintains the magnetic poles 380 and 380′ coupled to the magnetic support 350. In addition, in some embodiments, the retainer portion 360 can be configured to adhere (e.g., form a chemical bond) to a surface of the magnetic poles 380 and 380′ and a surface of the magnetic support 350 to couple the first magnetic pole 380 and the second magnetic pole 380′ to the magnetic support 350.

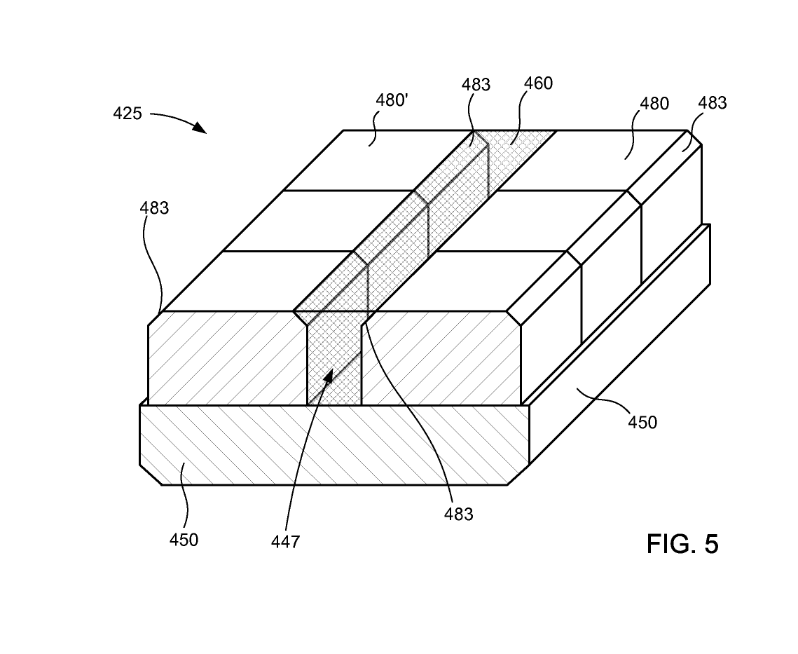

While the portion of the rotor element 325 is shown in FIGS. 4A-4C as including a retainer portion 360 that substantially encases or surrounds the magnetic poles 380. 380′, in other embodiments, the retainer portion can be applied such that the material of the retainer portion flows within a channel (e.g., channel 347) defined between magnetic poles and within a channel (e.g., channel 346) of the magnetic support but does not encase or surround the magnetic poles. For example, FIG. 5 is an illustration of a portion of a rotor element 425, according to another embodiment. The rotor element 425 (only a portion of the rotor element 425 is illustrated in FIG. 5) includes a magnetic support 450, a first magnetic pole assembly 480 (also referred to herein as “magnetic pole”) and a second magnetic pole assembly 480′ (also referred to herein as “magnetic pole”).

As with the rotor element 325 described above, the magnetic support 450 can define one or more channels (not shown) that include a flared or tapered portion defined by angled surfaces (not shown) of the magnetic support 450 in a similar manner as described above for magnetic support 350. The magnetic poles 480, 480′ collectively define a channel 447 in fluid communication with the channels 446 and each magnetic pole 480, 480′ includes an angled or tapered coupling portion 483.

As described above, the retainer portion 460 can couple the first magnetic pole 480 and the second magnetic pole 480′ to the magnetic support 450 and can be formed with the same as or similar materials, and function the same as or similar to, the retainer portion 360. For example, the retainer portion 450 can be a material that can be applied or allowed to flow within the channel 446 and the channel 448 during a first time period in which the material is in a first state (e.g., a liquid or substantially liquid state), and the material of the retainer member 460 can assume a second state (e.g., a solid) during a second time period as the material hardens or sets. Thus, the retainer portion 460 can be placed in contact with the angled coupling portions 483 of the first magnetic pole 480, the angled coupling portions 483 of the second magnetic pole 480′, and the angled surfaces of the magnetic support 450. Therefore, the retainer portion 460 can act to couple the magnetic poles 480 and the 480′ to the magnetic support 450.

While the rotor element 425 is shown in FIG. 5 as including a single retainer portion 460, as with the rotor element 325, the rotor element 425 can include multiple retainer portions, multiple magnetic pole assemblies 480 and multiple magnetic supports 450. For example, additional retainer portions 460 can be disposed on either side of the magnetic pole assemblies 480, 480′.

Also as described for rotor element 325, in alternative embodiments, the magnetic support 450 can include one or more elongate channels similar to the elongate channels 346 described above for rotor element 325 that extend substantially along an axial length of the magnetic poles 480, 480′. In other alternative embodiments, the magnetic support 450 may not include channels. In such an embodiment, the magnetic poles 480, 480′ can be surface bonded to the magnetic support 450.

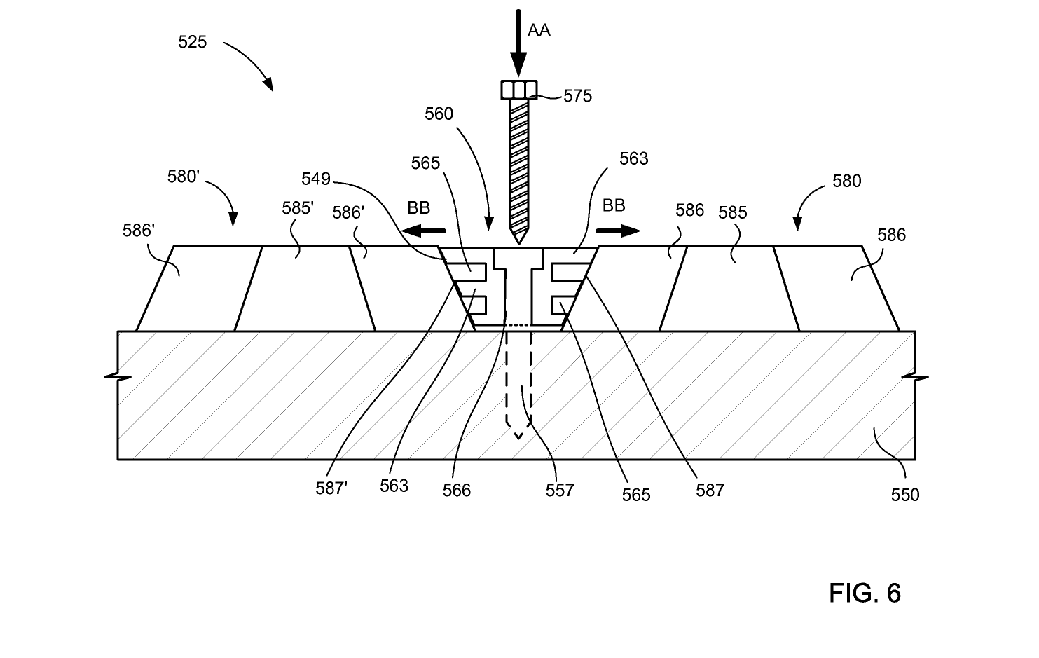

Referring now to FIG. 6, a portion of a rotor element 525 is illustrated according to another embodiment. The rotor element 525 can be included within a rotor assembly of an electromagnetic machine as described above for previous embodiments. The rotor element 525 includes a magnetic support 550, a first magnetic pole assembly 580 (also referred to herein as “first magnetic pole”), a second magnetic pole assembly 580′ (also referred to herein as “second magnetic pole”), a retainer member 560, and a coupler 575. The magnetic support 550 can be any suitable shape, size, or configuration. In this embodiment, the magnetic support 550 defines an opening 557 within a thickness of the magnetic support 550. In alternative embodiments, the opening 557 can extend through the entire thickness of the magnetic support 550. The opening 557 can receive a portion of the coupling member 575, as described in further detail below. The first magnetic pole 580 and the second magnetic pole 580′ (collectively referred to herein as “magnetic poles”) can be substantially similar in form, function, and arrangement as the magnetic pole assemblies previously described.

As shown in FIG. 6, the first magnetic pole 580 can be a magnet with outer magnet portions 586 disposed along the outer side edges of the first magnetic pole 580 adjacent to and on opposite sides of a center magnet portion 585. In some embodiments, the magnetic pole 580 can be a flux focusing magnet as described in detail in the '539 and '062 applications incorporated by reference above. In a similar manner, the second magnetic pole 580′ can include a center magnet portion 585′ and a pair of outer magnet portions 586′, which are substantially similar in form, function, and arrangement as the center magnet portion 585 and the outer magnet portions 586 of the first magnetic pole 580.

The first magnetic pole 580 includes an angled edge portion 587 and the second magnetic pole 580′ includes an angled edge portion 587′. The angled edge portion 587 and the angled edge portion 587′ collectively define an opening 549 in which the retainer member 560 can be disposed, as described in further detail below.

In this embodiment, the retainer member 560 is a deformable member that includes multiple elongates 563 that collectively define multiple recesses 565 therebetween. In alternative embodiments, a retainer member can include a single elongate. The retainer member 560 can be disposed within the opening 549 such that the elongates 563 extend outward toward the first magnetic pole 580 and the second magnetic pole 580′. The retainer member 560 also defines an opening or hole 566 that extends through the retainer member 560 that can receive the coupler 575.

As shown in FIG. 6, the retainer member 560 can have a cross-sectional shape and size such that the elongates 563 vary in length to define angled side edges of the retainer member 560 that substantially correspond to the angled surfaces 587 and 587′ of the first magnetic pole 580 and the second magnetic pole 580′, respectively. Expanding further, the retainer member 560 can be disposed within the opening 549 such that a portion of each of the elongates 563 is in contact with the angled edge portions 587 and 587′ of the first magnetic pole 580 and the second magnetic pole 580′, respectively, and a bottom surface of the retainer member 560 is at a non-zero distance from a top surface of the magnetic support 550 as shown in FIG. 6.

The coupler 575 can be any suitable coupling mechanism. For example, in some embodiments, the coupler 575 is a mechanical fastener such as, a bolt or other threaded fastener. In this manner, the coupler 575 can be inserted into the opening 566 defined by the retainer member 560, in the direction of arrow AA in FIG. 6. The relative sizes of the coupler 575 and the channel 566 of the retainer member 560 can be such that as the coupler 575 is advanced through the channel 566 of the retainer member 560 toward the magnetic support 550, the retainer member 560 is urged to deform substantially outward in a direction of arrows BB. In some embodiments, the deformation of the retainer member 560, as urged by the coupler 575, produces a plastic deformation of the retainer member 560. Similarly stated, the coupler 575 can deform the retainer member 560 a sufficient amount such that the retainer member 560 is permanently deformed. Moreover, as the coupler 575 is drawn in the direction of arrow AA, the angled edges of the elongates 563 exert a force on the angled edge portions 587 and 587′ of the first magnetic pole 580 and the second magnetic pole 580′, respectively, in a direction of arrow BB. In this manner, the stresses within the retainer member 560 can be such that the retainer member 560 is strain hardened as a result of the plastic deformation produced by the coupler 575. In addition, the coupler 575 can be advanced through the channel 566 defined by the retainer member 560 and into the opening 557 defined by the magnetic support 550 and threadably coupled to the magnetic support 550. When the coupler 575 is fastened to the magnetic support 550, the elongates 563 can be deformed outward and upward and the bottom surface of the retainer member 560 can be in contact with the top surface of the magnetic support 550. Thus, the retainer member 560 (e.g., in the deformed state) and the coupler member 575 can exert a compression force on the angled edge portions 587 and 587′ and the magnetic support 550 to couple the first magnetic pole 580 and the second magnetic pole 580′ to the magnetic support 550.

While the retainer member 560 is described above as being plastically deformed, in other embodiments, the retainer member 560 need not be plastically deformed. For example, in some embodiments, the retainer member 560 can be elastically deformed such that the deflection of the retainer member 560 is not a permanent deflection. For example, upon removal of the coupler 575, the retainer member 560 can return to substantially the same configuration as prior to being deformed. In other embodiments, the retainer member 560 need not be deflected by the coupler 575. In some embodiments, the retainer member 560 can be formed from a material that is strain hardened such as, for example, strain hardened aluminum or strain hardened steel. In this manner, the retainer member 560 can be formed to define any desirable hardness, strength, elasticity, ductility, or the like.

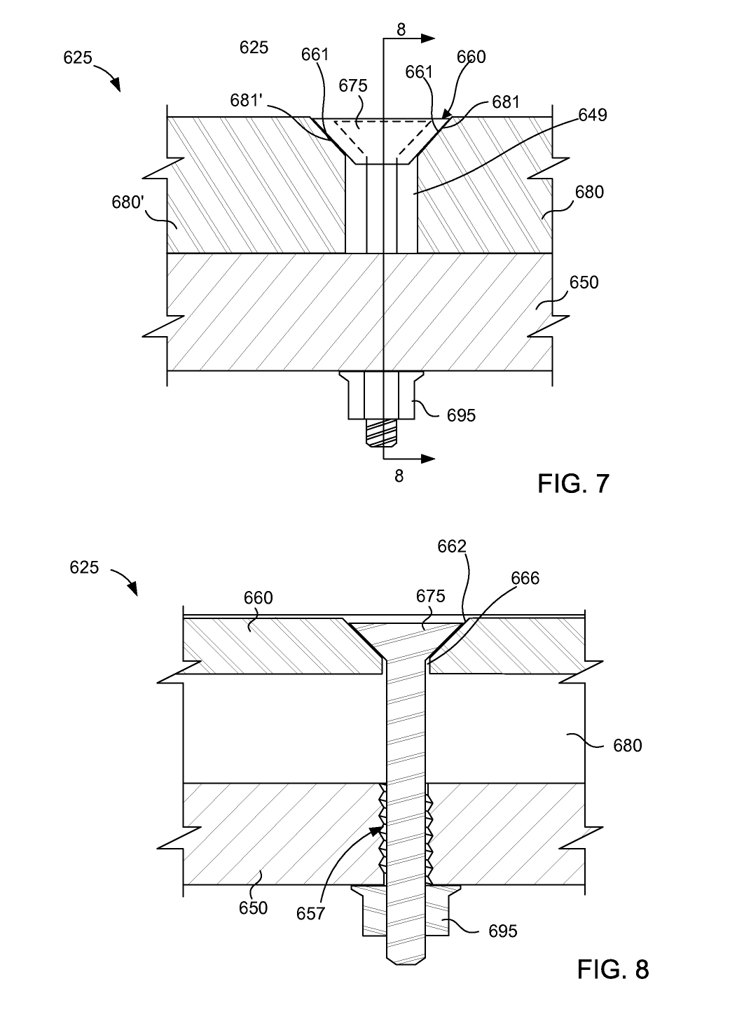

FIGS. 7 and 8 illustrate a portion of a rotor element 625, according to another embodiment. As shown in FIG. 7, the rotor element 625 includes a magnetic support 650, a first magnetic pole assembly 680 (also referred to herein as “first magnetic pole”), a second magnetic pole assembly 680′ (also referred to herein as “second magnetic pole”), a retainer member 660, a coupler 675, and a fastener 695. The magnetic support 650 defines a channel 657 that can receive a portion of the coupler 675, as described in further detail below. The magnetic assembly 650 can be substantially similar to previous embodiment of a magnetic support described above, and therefore, is not described in further detail herein.

The first magnetic pole 680 and the second magnetic pole 680′ (collectively referred to herein as “magnetic poles”) can be substantially similar in form, function, and arrangement. Therefore, the second magnetic pole 680′ is not described in detail and it should be understood that a discussion of the first magnetic pole 680 applies to the second magnetic pole 680′ unless explicitly described otherwise. Furthermore, the magnetic poles 680 and 680′ can be substantially similar to, and function the same as, previous embodiments of a magnetic poles described above. Therefore, portions of the magnetic poles 680 and 680′ are not described in detail herein.

As shown in FIG. 7, the magnetic poles 680 and 680′ are disposed on the magnetic support 650 and collectively define an opening 649 between the magnetic pole 680 and the magnetic pole 680′. Moreover, the magnetic poles 680 and 680′ each include a coupling portion 681 and 681′, respectively. The coupling portions 681 and 681′ can be substantially angled and can be placed in contact with a portion of the retainer member 660, as further described below. In alternative embodiments, the coupling portions 681 and 681′ can be stepped or rabbeted, round or radiused, notched, flat, concave or any other shape or configuration rather than an angled surface that can receive a portion of the retainer member 660.

The retainer member 660 includes a first coupling portion 661 and a second coupling portion 662. As shown in FIG. 7, the first coupling portion 661 is a substantially angled portion of the retainer member 660 and can contact the angled coupling portions 681 and 681′ of the magnetic poles 680 and 680′. While shown in FIG. 7 as defining a substantially trapezoidal cross-sectional shape, in other embodiments, the retainer member 660 can have any suitable cross-sectional shape. Similarly stated, as with the coupling portions 681 and 681′, the first coupling portion 661 of the retainer member 660 need not be angled (e.g., can alternatively be stepped or rabbeted, round or radiused, notched, flat, concave, etc.). The second coupling portion 662 of the retainer member 660 defines a channel 666 that receives a portion of the coupler 675. While shown in FIG. 8 as being countersunk, in other embodiments, the channel 666 need not be countersunk. For example, in some embodiments, the channel 666 includes a substantially constant diameter. In other embodiments, the channel 666 can include a shoulder or step configured to engage a portion of the coupler 675.

The coupler 675 can be any suitable coupler. For example, in some embodiments, the coupler 675 is a mechanical fastener such as, a bolt with a threaded portion that can be removably coupled to the retainer member 660. In alternative embodiments, the coupler 675 can be, for example, a rivet or other type of permanent coupler. As shown in FIG. 8, the coupler 675 can be inserted into the channel 666 defined by the retainer member 660 and into the channel 657 defined by the magnetic support 650 such that a portion of the coupler 675 extends beyond a surface of the magnetic support 650. In this manner, the fastener 695 (e.g., a nut) can be disposed about the threaded portion of the coupler 675 (e.g., via a threaded coupling). Moreover, the fastener 695 can be advanced along a length of the coupler 675 to engage the surface of the magnetic support 650. Therefore, as the fastener 695 is advanced, the coupler 675 exerts a compression force on the second coupling portion 662 of the retainer member 660. Substantially simultaneously, the first coupling portion 661 of the retainer member 660 transfers a portion of the compression force to the coupling portions 681 and 681′ of the magnetic poles 680 and 680′, respectively, to couple the magnetic poles 680 and 680′ to the magnetic support 650.

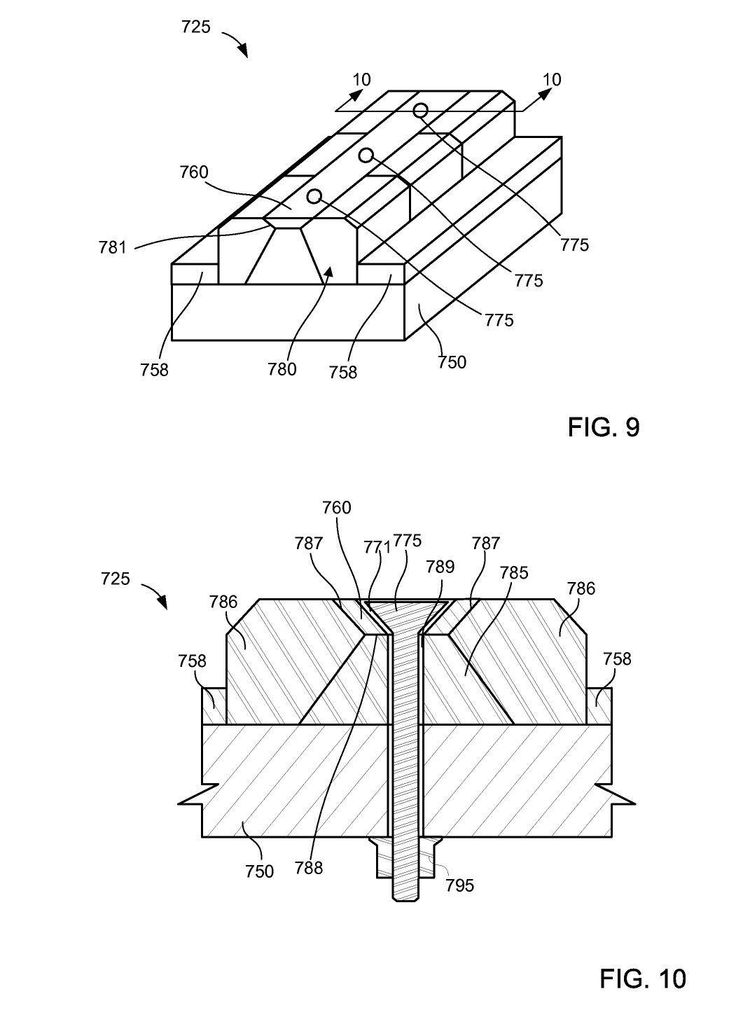

While the retainer member 660 is shown in FIGS. 7 and 8 as coupling the first magnetic pole 680 and the second magnetic pole 680′ to the magnetic support 650, in some embodiments, a retainer member can couple a single magnetic pole to a magnetic assembly. For example, FIGS. 9 and 10 illustrate a rotor element 725 according to another embodiment. As shown in FIG. 9, the rotor element 725 includes a magnetic support 750, a magnetic pole assembly 780 (also referred to herein as “magnetic pole”), a retainer member 760, multiple couplers 775, and multiple fasteners 795. While FIGS. 9 and 10 illustrate the magnetic support 750 with a single magnet pole 780 coupled thereto, in other embodiments, a rotor element can include multiple magnetic poles coupled to a magnetic support.

In this embodiment, the magnetic support 750 defines openings (not shown) that can each receive a portion of a coupler 775, as described in further detail below. The magnetic support 750 can further include retention members 758 that can position the magnetic pole 780 relative to the magnetic support 750 and facilitate a transfer of a portion of a magnetic flux if made from a magnetically permeable material. A detailed description of the form and function of such retention members 758 is included, for example, in the '791 application incorporated by reference above.

The magnetic pole 780 can include two outer magnets 786 disposed along the outer side edges of the magnetic pole 780 adjacent to and on opposite sides of a center magnet 785. As shown in FIG. 10, the two outer magnets 786 and the center magnet 785 collectively define a coupling portion 781 of the magnetic pole 780 that includes a channel that extends along a length of the magnetic pole 780. More specifically, each of the outer magnets 786 can include an angled portion 787 such that a top surface 788 of the center magnets 785 and the angled surface 787 of each of the outer magnets 786 form the coupling portion 781 (e.g., channel). In addition, the center magnets 785 can each define an opening or hole 789 that can receive a portion of the coupler 775, as described in further detail below.

In this embodiment, the retainer member 760 can be formed from a ferromagnetic material and can be used to direct a portion of a magnetic flux flow. Similarly stated, the retainer member 760 can at least partially function as a magnetic lens such as those described in detail in the '539 and '062 applications. In an embodiment in which the retainer member is disposed between magnetic poles (for example, retainer member 660 described above), it may be desirable to form the retainer member with a magnetically impermeable material to prevent flux leakage.

As shown in FIGS. 9 and 10 the retainer member 760 can be disposed within the coupling portion 781 (e.g., channel) of the first magnetic pole 780. The couplers 775 can each be inserted through an opening 771 (shown in FIG. 10) defined by the retainer member 760, through the channels 789 defined by the center magnets 785, and through openings (not shown) defined by the magnetic support 750 such that a portion of the couplers 775 extend beyond a surface of the magnetic support 750. In this manner, the fastener 795 (e.g., a nut) can be disposed about the threaded portion of the coupler 775 (e.g., via a threaded coupling). Moreover, the fastener 795 can be advanced along a length of the coupler 775 to engage the surface of the magnetic support 750. Therefore, as the fastener 795 is advanced, the coupler 775 exerts a compression force on the retainer member 760. Substantially simultaneously, the retainer member 760 can transfer a portion of the compression force to the coupling portion 781 of the magnetic pole 780 to couple the magnetic pole 780 to the magnetic support 750.

In an alternative embodiment, the openings in the magnetic support 750 configured to receive the couplers 775 may not extend through the entire thickness of the magnetic support 750. In such an embodiment, the magnetic support 750 can be tapped or threaded to threadably couple the couplers 775 thereto. In some alternative embodiments, the retainer member 750 can be adhesively coupled or bonded to the magnetic pole 780 rather than using the couplers 775.

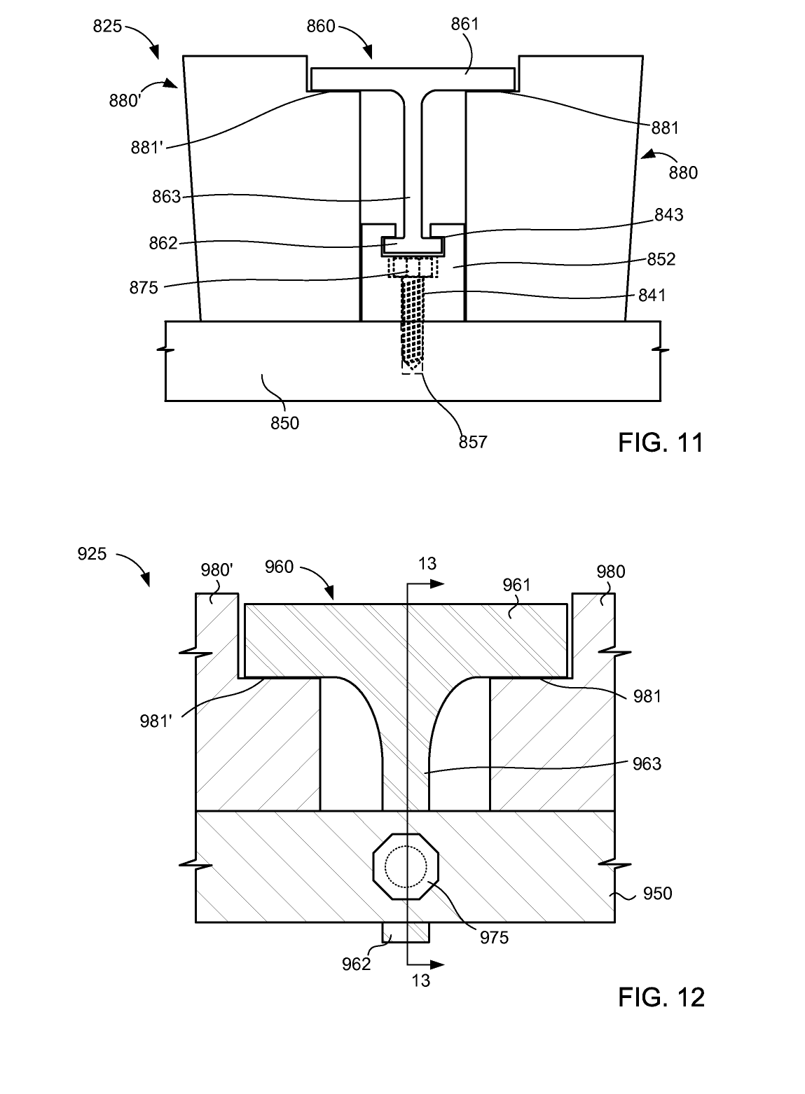

FIG. 11 illustrates a portion of a rotor element 825, according to another embodiment. The rotor element 825 includes a magnetic support 850, a first magnetic pole assembly 880 (also referred to herein as “first magnetic pole”), a second magnetic pole assembly 880′ (also referred to herein as “second magnetic pole”), a retainer member 860, and a coupler 875. The magnetic support 850 can be any suitable shape, size, or configuration and can function the same as or similar to the magnetic supports described for previous embodiments. For example, the magnetic support 850 can be formed from a ferromagnetic material such as, for example, steel.

In this embodiment, a bracket 852 is coupled to the magnetic support 850 with a coupler 875. For example, the bracket 852 defines an opening 841 in fluid communication with an opening 857 defined by the magnetic support 850. The coupler 875 can be, for example, a threaded fastener that can be inserted within the opening 841 and the opening 857 and threadably coupled to magnetic support 850. The bracket 852 also defines a T-shaped channel 843 that can slidably receive a T-shaped portion of the retainer member 860 as described in more detail below. While the bracket 852 is shown in FIG. 11 as being coupled to the magnetic support 850, in other embodiments, the bracket 852 can be monolithically formed with the magnetic support 850. Thus, in such an embodiment, the coupler 875 need not be included.

The first magnetic pole 880 and the second magnetic pole 880′ (collectively referred to herein as “magnetic poles”) can be substantially similar in form, function, and arrangement to the magnetic poles described above for previous embodiments. For example, the magnetic pole assemblies 880 and 880′ can each include multiple magnets, such as, for example, a pair of splitter magnets and a center magnet that are substantially similar to those described above with reference to FIG. 6.

As shown in FIG. 11, the magnetic poles 880 and 880′ include a coupling portion 881 and 881′, respectively. The coupling portions 881 and 881′ can be any suitable shape, size, or configuration. For example, the coupling portions 881 and 881′ can be a step defined by an upper surface of the magnetic poles 880 and 880′, respectively. In other embodiments, the coupling portions 881 and 881′ can define an angled edge portion. In this manner, the coupling portions 881 and 881′ can be placed in contact with a portion of the retainer member 860, as described below.

The retainer member 860 includes a first coupling portion 861, a second coupling portion 862, and an elongate portion 863. As shown, for example, in FIG. 11, in this embodiment, the first coupling portion 861 is a first T-shaped portion of the retainer member 860. Expanding further, the first coupling portion 861 is disposed at a first end of the elongate portion 863 and can extend in a substantially perpendicular direction relative to the elongate portion 863. Similarly, the second coupling portion 862 is disposed at a second end of the elongate portion 863 and can extend in a substantially perpendicular direction relative to the elongate portion 863. In this embodiment, the second coupling portion 862 includes a second T-shaped portion that can be matingly and slidably received within the T-shaped channel 843 defined by the bracket 852.

Furthermore, the walls of the bracket 852 that define the channel 843 are such that when the second coupling portion 862 of the retainer member 860 is disposed within the channel 843, the second coupling portion 862 cannot be substantially moved in an axial direction. Similarly stated, the bracket 852 of the magnetic support 850 is configured to slidably receive the retainer member 860 while substantially limiting the movement of the retainer member 860 in other directions. For example, for an axial flux machine as shown in FIG. 11, the retainer member 860 can move in a radial direction relative to the bracket 852 and be prevented or have limited movement in the axial and tangential directions.

Expanding further, in some embodiments, the retainer member 860 can be heated such that the elongate portion 863 of the retainer member 860 undergoes thermal expansion. In such embodiments, the thermal expansion of the elongate portion 863 can be such that the retainer member 860 assumes a suitable length to be substantially freely slid into the channel 843 defined by the bracket 852 of the back iron 850. With the first coupling portion 861 of the retainer member 860 in contact with the coupling portions 881 and 881′ of the first magnetic pole 880 and 880′, and with the second coupling portion 862 of the retainer member 860 disposed within the channel 843 of the bracket 852, the heat source can be removed from the retainer member 860. In this manner, the retainer member 860 is allowed to cool and, as such, returns to a length that is substantially shorter than a length that resulted from the thermal expansion of the elongate portion 863. The reduction of the length of the retainer member 860 is such that the second coupling portion 862 of the retainer member 860 can form an interference fit with at least a portion of the walls of the bracket 852 that define the channel 843, thereby substantially limiting a movement of the retainer member 860 in the radial, axial, and tangential directions, relative to the bracket 852 and magnetic support 850. In this manner, the stresses within the retainer member 860 can urge the retainer member 860 to exert a compression force on the coupling portions 881 and 881′ of the magnetic poles 880 and 880′, respectively, and on the second bracket 852 of the magnetic support 850, thereby coupling the magnetic poles 880 and 880′ to the magnetic support 850.

FIGS. 12-14 illustrate a portion of a rotor element 925, according to another embodiment. The rotor element 925 includes a magnetic support 950, a first magnetic pole assembly 980 (also referred to herein as “first magnetic pole”), a second magnetic pole assembly 980′ (also referred to herein as “second magnetic pole”), a retainer member 960, and a coupler 975. The first magnetic pole 980 and the second magnetic pole 980′ (collectively referred to herein as “magnetic poles”) can be substantially similar in form, function, and arrangement to magnetic pole assemblies described previously, and therefore, the magnetic poles 980 and the 980′ are not described in detail herein.

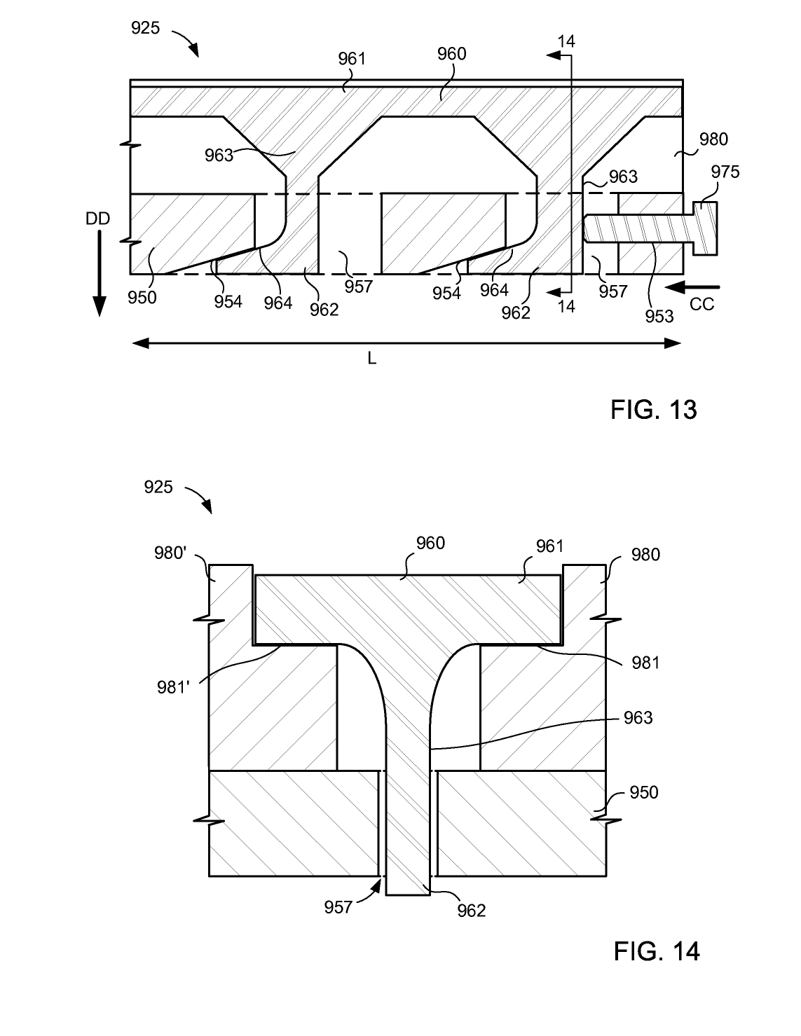

As shown in FIGS. 12 and 13, the magnetic poles 980 and 980′ each include a coupling portion 981 and 981′, respectively. The coupling portions 981 and 981′ can be any suitable shape, size, or configuration. For example, the coupling portions 981 and 981′ can be a step defined by a surface of the magnetic poles 980 and 980′, respectively. In other embodiments, the coupling portions 981 and 981′ can define an angled edge portion. In this manner, the coupling portions 981 and 981′ can receive a portion of the retainer member 960, as described in further detail herein.

The magnetic support 950 defines multiple channels 957 (shown in FIG. 13) and an opening 953 (shown in FIG. 14). As shown in FIG. 13, the magnetic support 950 also includes angled or ramped portions 954 that can be placed in contact with a portion of the retainer member 960, as described in more detail below. The channels 957 can extend through the magnetic support 950 and can receive a portion of the retainer member 960 (see e.g., FIG. 14). The opening 953 can extend through a portion of the magnetic support 950 and can be oriented substantially perpendicular to the channels 957. In this manner, the opening 953 can receive the coupler 975 (e.g., a bolt, a screw, or the like). Expanding further, the walls of the magnetic support 950 that define the opening 953 can be tapped such that the coupler 975 and the walls form a threaded coupling. As further described below, the coupler 975 can be advanced along the threads of the walls defining the opening 953 to engage a portion of the retainer member 960, as shown, for example, in FIGS. 12 and 13.

The retainer member 960 includes a first coupling portion 961 and multiple elongate portions 963, each including a second coupling portion 962. While shown in FIG. 13, as including two elongate portions 963, in other embodiments, the retainer member 960 can include any suitable number of elongate portions 963. Furthermore, the retainer member 960 can be such that the number of elongate portions 963 substantially corresponds to the number of channels 957 defined by the magnetic support 950.

The first coupling portion 961 of the retainer member 960 is disposed at a first end of the elongate portions 963 and can extend in a perpendicular direction relative to a length L of the retainer member 960 (see, e.g., FIG. 14). In this manner, the first coupling portion 961 can be placed in contact with the coupling portions 981 and 981′ of the magnetic poles 980 and 980′, respectively, as described in further detail herein. As shown in FIG. 13, the second coupling portions 962 are disposed at a second end of each elongate portion 963. The second coupling portions 962 extend from the elongate portions 963 along a portion of the length L of the retainer member 960. Similarly stated, the second coupling portions 962 extend from the elongate portions 963 in a substantially perpendicular direction relative to the first coupling portion 961. The second coupling portions 962 each include an angled surface 964 that can be placed in contact with a corresponding angled or ramped surface 954 of the magnetic support 950, as described below.

As shown in FIGS. 13 and 14, the channels 957 can receive the elongate portion 963 of the retainer member 960. More specifically, the channels 957 can be sufficiently large such that the second coupling portion 962 can be inserted through the channel 957 (FIG. 13). The retainer member 960 can then be moved in a direction of arrow CC shown in FIG. 13 such that the angled surfaces 964 of the second coupling portions 962 slidably engage the ramped surfaces 954 of the magnetic support 950. With the angled surfaces 964 engaged with the ramped surfaces 954 of the magnetic support 950, the coupler 975 can be advanced relative to the magnetic support 950, in the direction of arrow CC. In this manner, the coupler 975 can be placed into contact with a surface of the elongate portion 963 that is adjacent the coupler 975 to maintain the retainer member 960 coupled to the magnetic support 950.

Furthermore, as the angled surfaces 964 of the retainer member 960 are moved along the ramped surfaces 954 of the magnetic support 950, the retainer member 960 can also be moved in the direction of the arrow DD. Thus, the first coupling portion 961 of the retainer member 960 an be moved closer to the magnetic support 950 and exerts a compression force on the magnetic poles 980 and 980′ and the magnetic support 950 to couple the magnetic poles 980 and 980′ to the magnetic support 950.

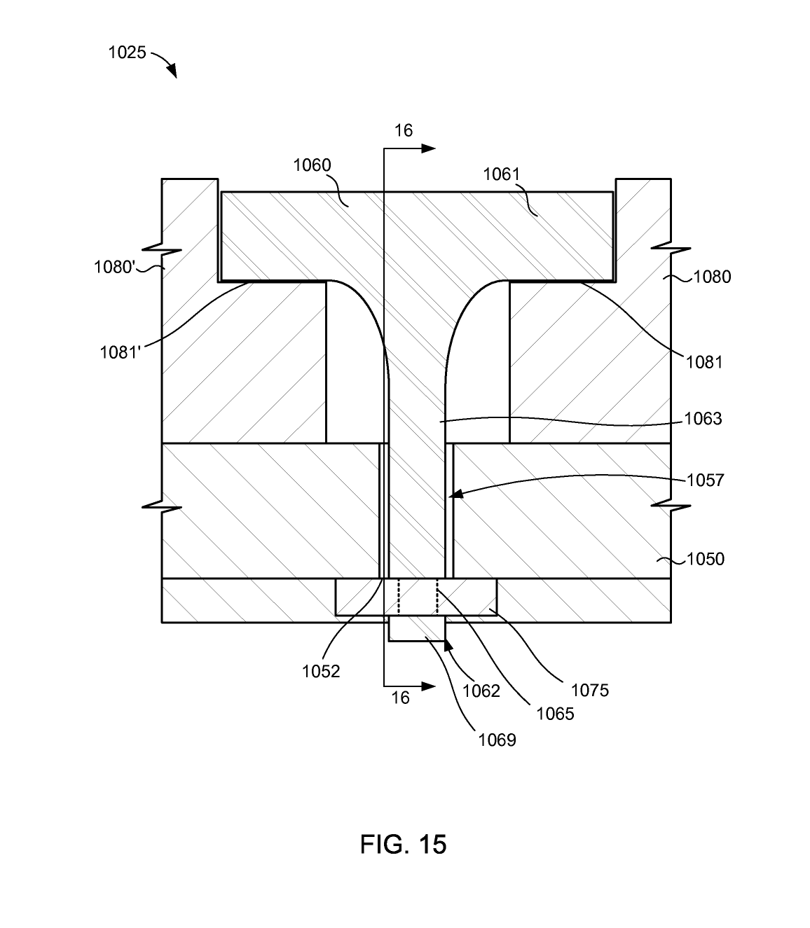

FIGS. 15-18 illustrate a portion of a rotor element 1025, according to another embodiment. The rotor element 1025 includes a magnetic support 1050, a first magnetic pole assembly 1080 (also referred to herein as “first magnetic pole”), a second magnetic pole assembly 1080′ (also referred to herein as “second magnetic pole”), a retainer member 1060, and a coupler 1075. The first magnetic pole 1080 and the second magnetic pole 1080′ (collectively referred to herein as “magnetic poles”) can be substantially similar in form, function, and arrangement to the magnetic pole assemblies described above for previous embodiments.

As shown in FIG. 15, the magnetic poles 1080 and 1080′ each include a coupling portion 1081 and 1081′, respectively. The coupling portions 1081 and 1081′ can be any suitable shape, size, or configuration. For example, the coupling portions 1081 and 1081′ can be a step defined by a surface of the magnetic poles 1080 and 1080′, respectively. In other embodiments, the coupling portions 1081 and 1081′ can define an angled edge portion. In this manner, the coupling portions 1081 and 1081′ can receive a portion of the retainer member 1060, as described in further detail herein.

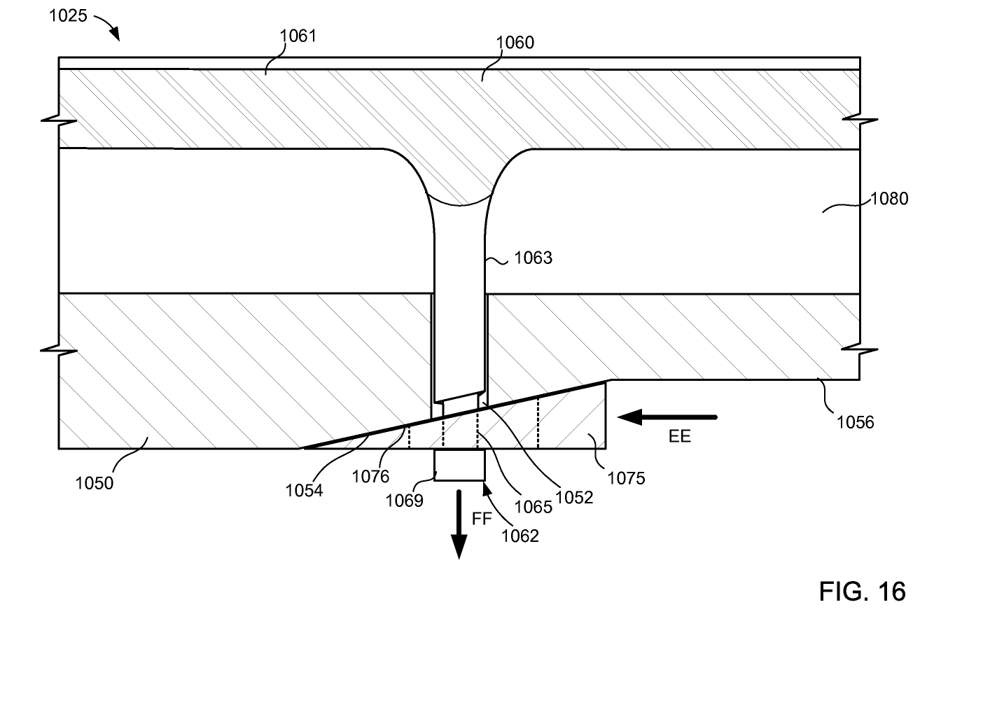

The magnetic support 1050 defines a channel 1057 as shown in FIG. 15. As shown in FIG. 16, the magnetic support 1050 includes a recessed region 1056 having an angled surface 1054. The angled surface 1054 of the recessed region 1056 that can be placed in contact with a portion of the coupler 1075, as described in further detail below. The channel 1057 can extend through a thickness of the magnetic support 1050 and is in fluid communication with an opening 1052 defined by the magnetic support 1050 at the angled surface 1054. In this manner, the channel 1057 can receive a portion of the retention member 1060 such that the portion of the retention member 1060 extends from the angled surface 1054, as further described below.

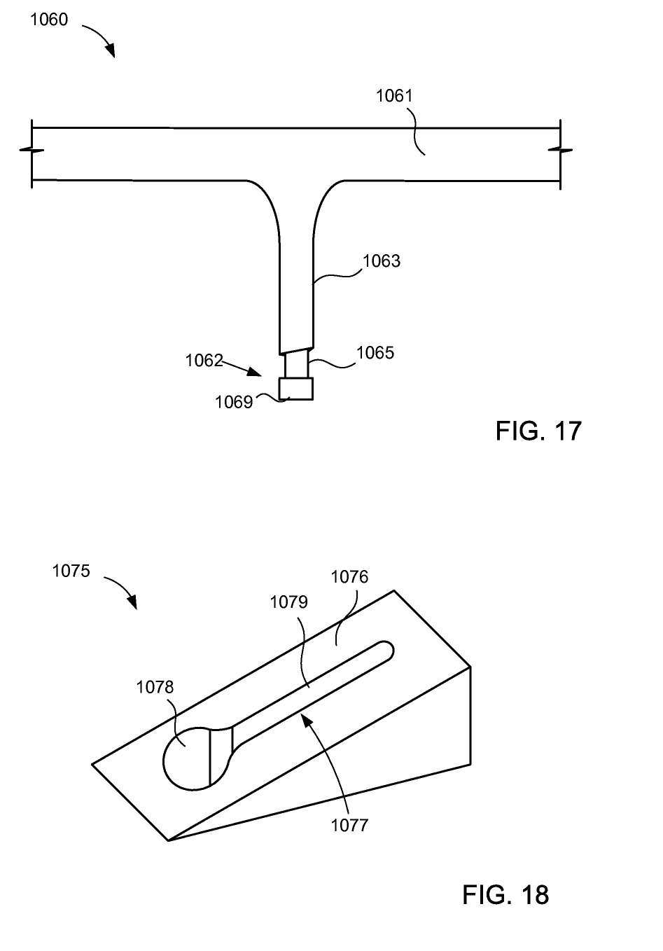

The retainer member 1060 includes a first coupling portion 1061, a second coupling portion 1062, and an elongate portion 1063. The first coupling portion 1061 of the retainer member 1060 is disposed at a first end of the elongate portion 1063 and can extend in a perpendicular direction relative to the elongate portion 1063 (see, e.g., FIG. 15). In this manner, the first coupling portion 1061 can be placed in contact with the coupling portions 1081 and 1081′ of the magnetic poles 1080 and 1080′, respectively, as described in further detail below. The second coupling portion 1062 is disposed at a second end portion of the elongate portion 1063 and includes a recessed surface 1065 and a pin element 1069 (see, e.g., FIG. 17). In this manner, the second coupling portion 1062 can engage a portion of the coupler 1075, as described in further detail below. The pin element 1069 can have various shapes and sizes. For example, the pin element 1069 can have a circular cross-section or an oval or elliptical cross-section.

As shown in FIGS. 16 and 18, the coupler 1075 can be substantially wedge shaped and includes an angled surface 1076. The coupler 1075 defines a channel or keyway 1077 that includes a first portion 1078 and a second portion 1079. The first portion 1078 of the channel 1077 can be substantially cylindrical and can have a diameter that substantially corresponds to the diameter or perimeter of the elongate portion 1063 of the retainer member 1060. More specifically, the diameter of the first portion 1078 of the channel 1077 can be sufficiently large such that the first portion 1078 can receive the pin element 1069 of the retainer member 1060. The second portion 1079 of the channel 1077 can be substantially elongate and can have a width that is smaller than the diameter of the first portion 1078. Moreover, the width of the second portion 1079 can substantially correspond to the diameter or perimeter of the recessed surface 1065 of the retainer member 1060. Similarly stated, the second portion 1079 can be sufficiently large such that the second portion 1079 can receive the portion of the retainer member 1060 at the recessed surface 1065.

As shown, for example, in FIG. 16, the elongate portion 1063 of the retainer member 1060 can be disposed within the channel 1057 defined by the magnetic support 1050, and the first coupling portion 1061 can be placed in contact with the coupling portions 1081 and 1081′ of the magnetic poles 1080 and 1080′. Moreover, the second coupling portion 1062 of the retainer member 1060 extends through the opening 1052 of magnetic support 1050 at the angled surface 1054. In this manner, the coupler 1075 can then be used to secure the retainer member 1060 to the magnetic support 1050. For example, the pin element 1069 can be placed through the first portion 1078 of the channel 1077 and the coupler 1075 can be moved or slid relative to the retainer member 1060.

More specifically, with the pin element 1069 of the second coupling portion 1062 disposed in the first portion 1078 of the channel 1077, the angled surface 1076 of the coupler 1075 can be brought into contact with the angled surface 1054 of the notch 1056, thereby aligning the recessed surface 1065 of the second coupling portion 1062 with the second portion 1079 of the channel 1077. In this manner, the angled surface 1076 of the coupler 1075 can be moved along the angled surface 1054 of the notch 1056 in a direction of arrow EE in FIG. 16 such that the recessed surface 1065 is disposed within the second portion 1079 of the channel 1077. The wedge shape of the coupler 1075 is such that as the angled surface 1076 of the coupler 1075 is moved along the angled surface 1054 of the recessed region 1056, and a portion of the coupler 1075 engages a top surface of the pin element 1069 of the retainer member 1060 to move or draw the retainer member 1060 in the direction of the arrow FF. Therefore, the retainer member 1060 and the coupler 1075 collectively exert a compression force on the magnetic poles 1080 and 1080′ and the magnetic support 1050 to couple the magnetic poles 1080 and 1080′ to the magnetic support 1050. Thus, the coupler 1075 can be held in position with a friction force where additionally the surface 1076 and the surface 1054 may be prepared or configured to increase the friction coefficient. In some embodiments, alternatively or in addition to the friction force, the coupler 1075 can be held in position with, for example, adhesive, welding, soldering or a threaded fastener.

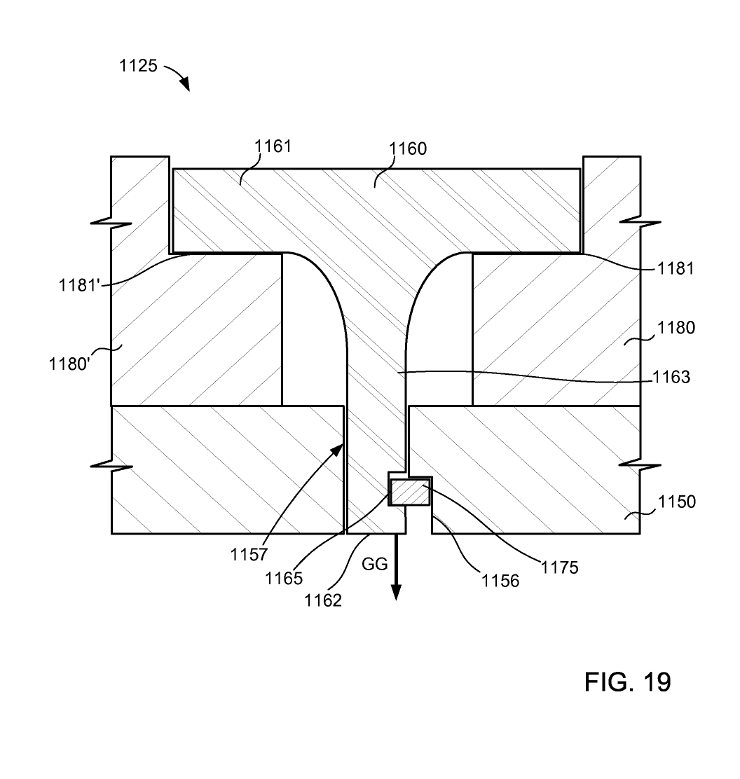

While the elongate portion 1063 of the retainer member 1060 is shown in FIGS. 15-18 as being disposed within the channel 1077 defined by the coupler 1075, in other embodiments, a rotor element can include a coupler that can be at least partially disposed in a recess defined by the retention member. For example, FIG. 19 is an illustration of a portion of a rotor element 1125, according to an embodiment. The rotor element 1125 includes a magnetic support 1150, a first magnetic pole assembly 1180 (also referred to herein as “first magnetic pole”), a second magnetic pole assembly 1180′ (also referred to herein as “second magnetic pole”), a retainer member 1160, and a coupler 1175. The first magnetic pole 1180 and the second magnetic pole 1180′ (collectively referred to herein as “magnetic poles”) include a coupling portion 1181 and 1181′, respectively and can be substantially similar to the magnetic poles described above for previous embodiments.

The magnetic support 1150 defines a channel 1157 that can receive a portion of the retainer member 1160 and a notch 1156 configured to receive a portion of the coupler 1175, as further described below. In this manner, the magnetic support 1150 can be similar to the magnetic support 1050 described above with reference to FIGS. 15-18. Moreover, while not shown in FIG. 19, the notch 1156 of the magnetic support 1150 can include an angled surface that is similar to the angled surface 1054 described above with reference to FIGS. 15-18.

The retainer member 1160 includes a first coupling portion 1161, a second coupling portion 1162, and an elongate portion 1163. The first coupling portion 1161 of the retainer member 1160 is substantially similar to the first coupling portion 1061 of the retainer member 1060 described above with reference to FIGS. 15-18. In this embodiment, the second coupling portion 1162 is disposed at a side portion of the elongate portion 1163 and includes a recess or cutout 1165. Similar to the second coupling portion 1062 described above, the second coupling portion 1162 can engage a portion of the coupler 1175, as described in further detail below.

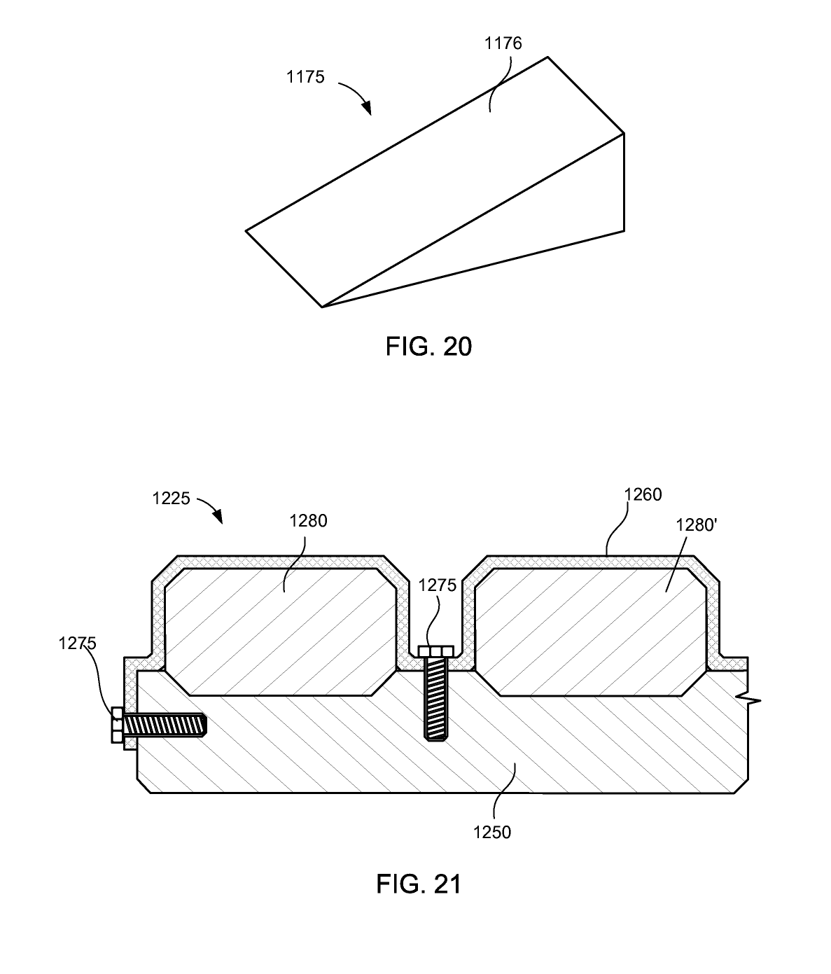

As shown in FIG. 20, the coupler 1175 can be substantially wedge shaped and can include an angled surface 1176 (e.g., similar to the angled surface 1076 of the coupler 1075 shown in FIG. 18). In this manner, the coupler 1175 can engage the second coupling portion 1162 of the retainer member 1160 and a surface of the magnetic support 1150 defining the notch 1156.

As shown in FIG. 19, with the elongate portion 1163 of the retainer member 1160 disposed within the channel 1157 defined by the magnetic support 1150, the first coupling portion 1161 is placed in contact with the coupling portions 1181 and 1181′ of the magnetic poles 1180 and 1180′. Moreover, a portion of the recess 1165 defined by the second coupling portion 1162 is aligned with a portion of the notch 1156 defined by the magnetic support 1150. In this manner, the coupler 1175 can be inserted into an open space or region collectively defined by the portion of the recess 1165 and the portion of the notch 1156. Expanding further, the wedged shaped arrangement of the coupler 1175 is such that as the angled surface 1176 of the coupler 1175 is moved along an angled surface (not shown in FIG. 19) of the notch 1156, and a portion of the coupler 1175 can engage a surface of the second coupling portion 1062 within the cutout 1165 of the retainer member 1160 such that the retainer member 1160 is moved or drawn in the direction of the arrow GG. Therefore, the retainer member 1160 and the coupler 1175 collectively exert a compression force on the magnetic poles 1180 and 1180′ and the back iron 1150 to couple the magnetic poles 1180 and 1180′ to the magnetic support 1150.

FIG. 21 is a cross-sectional view of a portion of a rotor element 1225, according to another embodiment. The rotor element 1225 includes a magnetic support 1250, a first magnetic pole assembly 1280 (also referred to herein as “first magnetic pole”), a second magnetic pole assembly 1280′ (also referred to herein as “second magnetic pole”), a retainer member 1260, and couplers 1275. The first magnetic pole 1280 and the second magnetic pole 1280′ (collectively referred to herein as “magnetic poles”) can be substantially similar to the magnetic poles described above for previous embodiments. Similarly, the magnetic support 1350 can be formed the same as or similar other magnetic supports described herein.

In this embodiment, the retainer member 1260 (also referred to herein as “retainer portion”) is in the form of a cover that can be disposed over a portion of the magnetic poles 1280, 1280′ and coupled to the magnetic support 1250 with couplers 1275. The retainer member 1260 can be a thin sheet formed with, for example, a non-magnetic material, a magnetic permeable material, or a strategic combination of such materials. The retainer member 1260 can be configured to substantially cover multiple magnetic poles or can be sized and configured as a cover strip that covers a portion of one or more magnetic poles. For example, the retainer member 1260 can substantially cover the magnetic poles 1280 and 1280′ or can be a strip that extends across a portion of each of magnetic pole 1280 and magnetic pole 1280′. Thus, the rotor element 1225 can include one or multiple retainer members 1260.

The couplers 1275 can be used to couple the retainer member 1260 to the magnetic support 1250 as shown in FIG. 21. For example, the couplers 1275 can be threaded fasteners that can be threadably secured to a threaded or tapped hole in the magnetic support 1250. In alternative embodiments, the couplers 1275 can be, for example, rivets or other type of permanent coupler. One or multiple couplers 1275 can be used at various locations on the rotor element 1225.

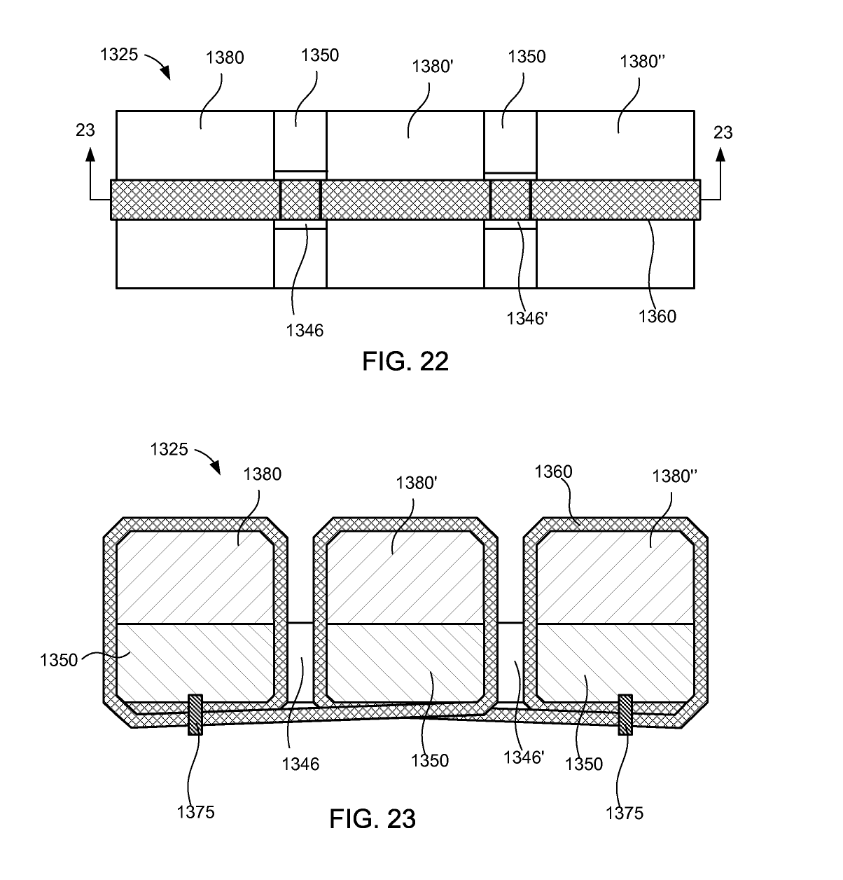

FIGS. 22 and 23 illustrate a portion of a rotor element according to another embodiment. A rotor element 1325 includes a magnetic support 1350, a first magnetic pole assembly 1380 (also referred to herein as “first magnetic pole”), a second magnetic pole assembly 1380′ (also referred to herein as “second magnetic pole”), a third magnetic pole assembly 1380″ (also referred to herein as “third magnetic pole”), a retainer member 1360, and couplers 1375. The first magnetic pole 1380, second magnetic pole 1380′, and third magnetic pole 1380″ (collectively referred to herein as “magnetic poles”) can be substantially similar to the magnetic poles described above for previous embodiments. Similarly, the magnetic support 1350 can be formed the same as or similar other magnetic supports described herein.

In this embodiment, the retainer member 1360 (also referred to herein as “retainer portion”) is in the form of a band that extends over and around a portion of the magnetic poles 1380, 1380′ and 1380″ and a portion of the magnetic support 1350. The retainer member 1360 (e.g., band) can be formed with various materials, such as, for example, a fiber wound material, one or more plastic materials and/or one or more metal materials. The retainer member 1360 can be wrapped or wound around the magnetic poles 1380, 1380′, 1380″ and the magnetic support 1350 and then tensioned with the couplers 1375. For example, the couplers 1375 can be a clamp such as a band clamp, a zip tie, a crimp, etc. and can include other fasteners such as threaded fasteners or rivets to secure the retainer member in a tensioned configuration. In addition, a tool (not shown) can be used to tighten the couplers 1375. As shown in FIGS. 22 and 23, the magnetic support 1350 defines an opening(s) 1346 between the magnetic poles 1380 and 1380′ and opening(s) 1346′ between the magnetic poles 1380′ and 1380″. The retainer member 1360 can be wrapped around the magnetic poles, through the openings 1346 and 1346′ and around the magnetic support 1350 as shown, for example, in FIG. 23.

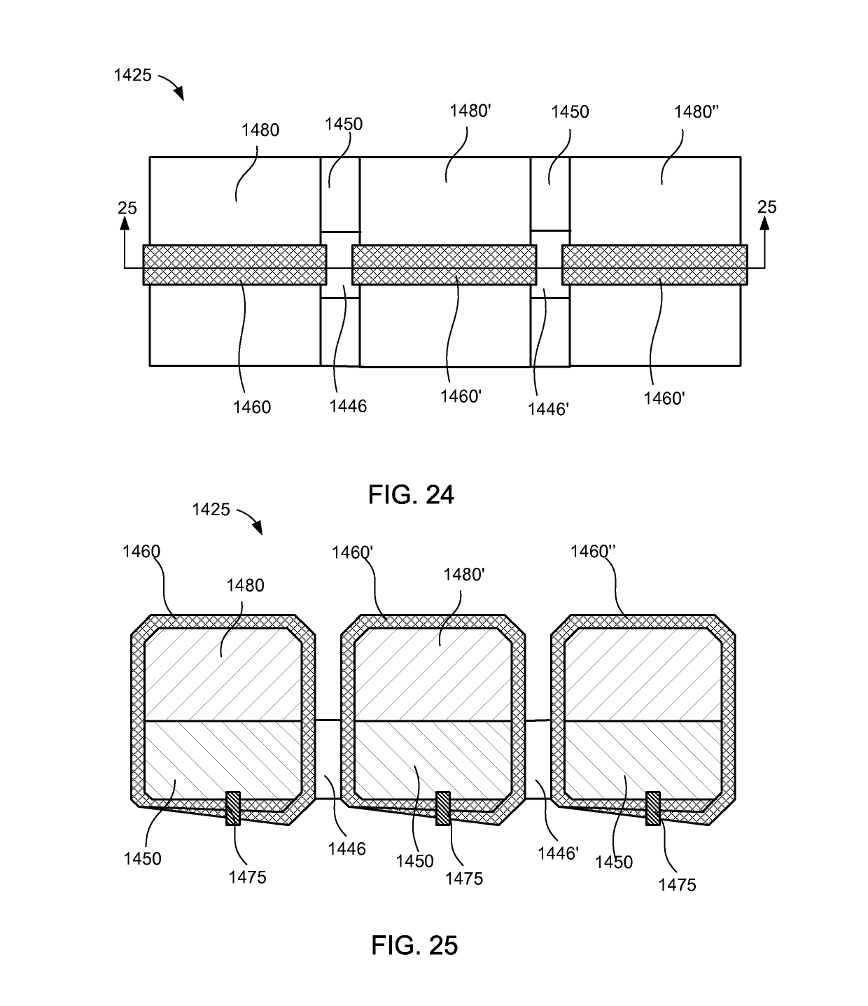

FIGS. 24 and 25 illustrate a portion of a rotor element according to another embodiment that is similar to the rotor element 1325. A rotor element 1425 includes a magnetic support 1450, a first magnetic pole assembly 1480 (also referred to herein as “first magnetic pole”), a second magnetic pole assembly 1480′ (also referred to herein as “second magnetic pole”), a third magnetic pole assembly 1480″ (also referred to herein as “third magnetic pole”), a first retainer member 1460, a second retainer member 1460′, a third retainer member 1460″, and couplers 1475. The first magnetic pole 1480, second magnetic pole 1480′, and third magnetic pole 1480″ (collectively referred to herein as “magnetic poles”) can be substantially similar to the magnetic poles described above for previous embodiments. Similarly, the magnetic support 1450 can be formed the same as or similar other magnetic supports described herein.

In this embodiment, the retainer members 1460, 1460′, 1460″ are each in the form of a discrete band that extends over and around a portion of the magnetic poles 1480, 1480′ and 1480″, respectively, and a portion of the magnetic support 1450. As with the retainer member 1360, the retainer members 1460, 1460′ and 1460″ can each be formed with various materials, such as, for example, a fiber wound material, one or more plastic materials and/or one or more metal materials. The retainer members 1460, 1460′, 1460″ can each be wrapped or wound around the respective magnetic pole 1480, 1480′, 1480″ and the magnetic support 1450 and then tensioned with a coupler 1475. The couplers 1475 can be a clamp such as a band clamp, a zip tie, a crimp, etc. and can include other fasteners such as threaded fasteners or rivets to secure the retainer members in a tensioned configuration. In addition, a tool (not shown) can be used to tighten the couplers 1475. As shown in FIGS. 24 and 25, the magnetic support 1450 defines an opening(s) 1446 between the magnetic poles 1480 and 1480′ and opening(s) 1446′ between the magnetic poles 1480′ and 1480″ such that the retainer members 1460, 1460′, 1460″ can be wrapped around the magnetic poles, through the openings 1446 and 1446′ and around the magnetic support 1450 as shown, for example, in FIG. 23.

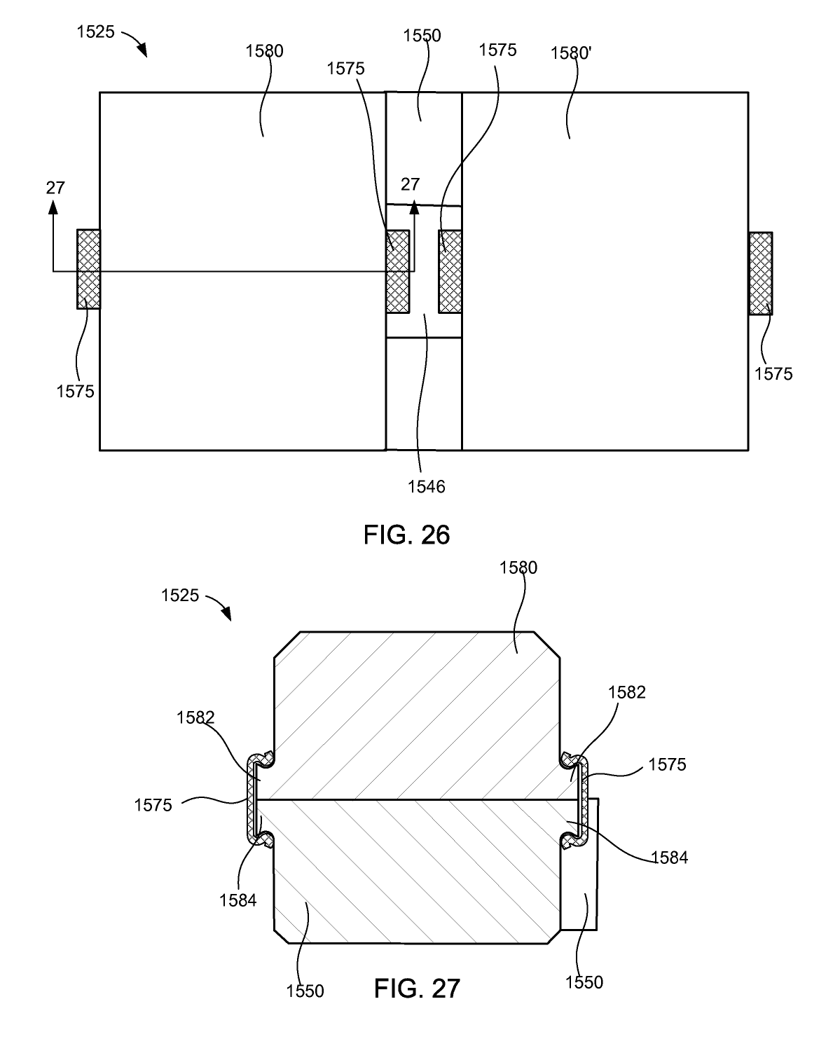

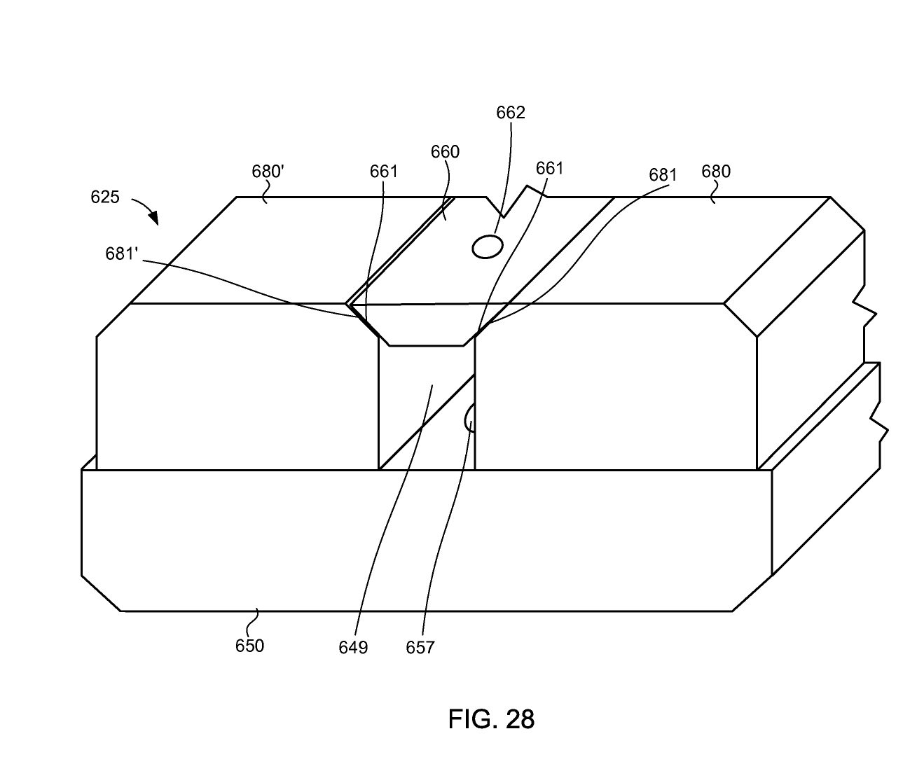

FIGS. 26 and 27 illustrate a portion of a rotor element according to yet another embodiment. A rotor element 1525 includes a magnetic support 1550, and a first magnetic pole assembly 1580 (also referred to herein as “magnetic pole”), a second magnetic pole assembly 1580′ and multiple retainer members 1560. The magnetic poles 1580, 1580′ can be substantially similar to the magnetic poles described above for previous embodiments and the magnetic support 1550 can be formed the same as or similar other magnetic supports described herein.

In this embodiment, the retainer members 1560 are each in the form of a clip that can be coupled to a portion of the magnetic poles 1580, 1580′ and a portion of the magnetic support 1550. The retainer members 1560 can be for example, a spring clip. The retainer members 1560 can be formed with a ferromagnetic material or a non-ferromagnetic material. In some embodiments, the retainer members 1560, 1560′ are formed with a stainless steel. The retainer members 1560 can be coupled to a coupling portion 1582 (shown in FIG. 27) on the magnetic poles 1580, 1580′ and a coupling portion 1584 (shown in FIG. 27) on the magnetic support 1550. A fastener (not shown) such as a threaded screw or a rivet can optionally be used to secure the retainer members 1560 to the magnetic support 1550 and the magnetic poles 1580, 1580′. The magnetic support 1550 can define openings 1546 to allow access to couple the retainer members 1560 to the coupling portions 1582 and 1584.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above

Where schematics and/or embodiments described above indicate certain components arranged in certain orientations or positions, the arrangement of components may be modified. While the embodiments have been particularly shown and described, it will be understood that various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

For example, a rotor element as described herein can be a variety of different shapes and/or sizes, and can include different quantities and types of magnetic pole assemblies than those shown with respect to specific embodiments. In another example, any of the rotor elements described herein can be sealed in any suitable manner such as those described herein. For example, in some embodiments wherein the retention element is a mechanical fastener, at least a portion of the rotor element (i.e., a portion of a magnetic pole, the retention element, the magnetic support, and/or coupler) can be coated in a corrosion resistant coating that can provide corrosion resistance.

It should also be understood that a magnetic pole assembly can include a coupling portion to couple to a retainer member that is either stepped or angled as shown in some embodiments, or can have a different shape or configuration to mate with a coupling portion of the retainer member. In another example, although the channel defined by the bracket 852 (FIG. 11) is T-shaped to slidably receive a T-shaped coupling portion of the retainer member 860, in alternative embodiments, the channel can have a different cross-section and receive a coupling portion on the retainer member that has a different shape.

In addition, it should be understood that the features, components and methods described herein can be implemented on a variety of different types of electromagnetic machines, such as, for example, axial, radial, and linear machines that can support rotational and/or linear or translational movement of a rotor assembly relative to a stator assembly. Furthermore, the features, components and methods described herein can be implemented in air core electromagnetic machines as well as iron core electromagnetic machines.

1-8. (canceled)

9. The apparatus of claim 34, wherein:
the retainer member is deformable by the coupler such that the first magnetic pole assembly and the second magnetic pole assembly are maintained coupled to the magnetic support.

10. The apparatus of claim 9, wherein the retainer member is plastically deformable by the coupler.

11. The apparatus of claim 9, wherein the retainer member is elastically deformable by the coupler.

12. The apparatus of claim 9, wherein the retainer member is formed with a strain hardening material.

13. The apparatus of claim 9, wherein the retainer member is disposed between the first magnetic pole assembly and the second magnetic pole assembly.

14. The apparatus of claim 9, wherein the angled edge portion of the first magnetic pole assembly and the angled edge portion of the second magnetic pole assembly collectively define a channel, the retainer member disposed within the channel.

15. The apparatus of claim 9, wherein
the retainer member is disposed between the first magnetic pole assembly and the second magnetic pole assembly, the coupler being received within an opening defined in the magnetic support.

16-22. (canceled)

23. An apparatus, comprising:
a rotor element configured to be disposed for rotational movement about an axis of rotation relative to a stator, the rotor element being spaced from the stator in an axial direction parallel to the axis of rotation, the rotor element including:
a magnetic support formed at least in part of a ferromagnetic material,
a first magnetic pole assembly coupled to the magnetic support,
a second magnetic pole assembly coupled to the magnetic support,
a retainer member having a first coupling portion matingly coupled to a coupling portion of the first magnetic pole assembly and to a coupling portion of the second magnetic pole assembly, and
a coupler configured to maintain the retainer member coupled to the first magnetic pole assembly, the second magnetic pole assembly and to the magnetic support, the coupler being elongate and extending in the axial direction.

24. The apparatus of claim 23, wherein the second coupling portion of the retainer member includes a wedged portion slidably coupled to a ramped portion on the magnetic support.

25. The apparatus of claim 23, wherein the coupling portion of the first magnetic pole assembly and the coupling portion of the second magnetic pole assembly collectively define an opening, the first coupling portion of the retainer member is received within the opening.

26. The apparatus of claim 23, wherein the coupling portion of the first magnetic pole assembly includes a first stepped shoulder, the coupling portion of the second magnetic pole assembly includes a second stepped shoulder, the first coupling portion of the retainer member includes a T-shaped portion matingly received within the first stepped shoulder and the second stepped shoulder.

27. The apparatus of claim 23, wherein the coupler is threadably coupled to a threaded opening defined by the magnetic support.

28. The apparatus of claim 23, wherein the coupling portion of the first magnetic pole assembly and the coupling portion of the second magnetic pole assembly collectively define a first opening, the magnetic support defines a second opening, the retainer member being disposed at least partially within the first opening and within the second opening.

29. The apparatus of claim 23, wherein the second coupling portion of the retainer includes a pin element, the coupler is a wedge element defining a keyway, the pin being slidably received within the keyway.

30. The apparatus of claim 23, wherein the second coupling portion of the retainer includes a cut-out defined by the retainer, the coupler is a wedge slidably disposed within the cut-out of the retainer.

31. The apparatus of claim 23, wherein the retainer member includes a second coupling portion configured to receive a portion of the coupler.

32. The apparatus of claim 23, wherein the retainer member has a substantially trapezoidal cross-sectional shape.

33. The apparatus of claim 23, wherein the coupling portion of the first magnetic pole assembly and the coupling portion of the second magnetic pole assembly each include an angled surface configured to matingly couple to a corresponding surface of the retainer member.

34. An apparatus, comprising:
a rotor element configured to be disposed for rotational movement about an axis of rotation relative to a stator, the rotor element being spaced from the stator in an axial direction parallel to the axis of rotation, the rotor element including:
a magnetic support;
a first magnetic pole assembly coupled to the magnetic support,
a second magnetic pole assembly coupled to the magnetic support,
the first magnetic pole assembly and the second magnetic pole assembly each having an angled edge portion;
a retainer member having a length and a width, the length being greater than the width and extending in a radial direction perpendicular to the axis of rotation, the retainer member having a first angled edge portion and a second angled edge portion configured to matingly engage the angled edge portion of the first magnetic pole assembly and angled edge portion of the second magnetic pole assembly, respectively; and
a coupler configured to maintain the retainer member coupled to the first magnetic pole assembly, the second magnetic pole assembly and to the magnetic support.

35. The apparatus of claim 34, wherein the first angled edge portion of the first magnetic pole assembly and the second angled edge portion of the second magnetic pole assembly collectively define an opening, the first retainer member being disposed within the opening.

36. The apparatus of claim 34, wherein the first coupler is threadably coupled to a threaded opening defined by the magnetic support.

37. The apparatus of claim 34, further comprising:
a fastener configured to be disposed about a threaded portion of the first coupler and engage a surface of the magnetic support such that a compression force is exerted on the first retainer member.

38. The apparatus of claim 23, wherein the first magnetic pole assembly and the second magnetic pole assembly are each coupled to the magnetic support such that the first magnetic pole assembly and the second magnetic pole assembly are each facing the stator in the axial direction.

39. The apparatus of claim 34, wherein the first magnetic pole assembly and the second magnetic pole assembly are each coupled to the magnetic support such that the first magnetic pole assembly and the second magnetic pole assembly are each facing the stator in the axial direction.
